(19) United States
(12) Patent Application Publication
(10) Pub. No.: US 2007/0212058 A1
(43) Pub. Date: Sep. 13, 2007

(54) Device for reducing dust-effects on an image

(75) Inventor: Sumio Kawai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Imaging Corp., Tokyo (JP)

(21) Appl. No.: 11/715,738

(22) Filed: Mar. 8, 2007

(30) Foreign Application Priority Data
Mar. 9, 2006 (JP) 2006-063809

(51) Int. Cl. G03B 19/00

(52) U.S. Cl. 396/429

(57) ABSTRACT

An image apparatus is disclosed, in which ions generated by an ion generator are forcibly moved along a dust-proof member for protecting an image surface from dust to remove dust adhering to the surface of the dust-proof member. An exemplary structure of the image apparatus of the present invention is as follows. An image apparatus comprises: an image surface on which the optical image is formed; a dust-proof member having a transparent portion in a region corresponding to the image surface, the transparent portion arranged to face the image surface with a predetermined space therebetween; an ion generator provided near the dust-proof member to generate negative or positive ions; and a transport part for moving ions generated by the ion generator along the surface of the dust-proof member.

### CROSS-REFERENCE TO RELATED APPLICATION

This application is based upon and claims the benefit of priority from prior Japanese Patent Application No. 2006-063809, filed on Mar. 9, 2006, the entire contents of which are incorporated herein by reference.

### BACKGROUND OF THE INVENTION

1. Field of the Invention

The present invention relates to a device for reducing dust-effects on an image, which is arranged in the optical path of an image apparatus for image formation to remove dust adhering to an optical element through which a light beam for image formation passes in order to reduce the effect of casting dust specks on an image. Specific examples of image apparatus include an electronic imaging apparatus, for example, such as a lens-interchangeable single-lens reflex digital camera, provided with an image pickup device for acquiring an image signal according to light irradiated onto its photoelectric conversion surface, a liquid crystal projector for projecting to a screen an image displayed on a liquid crystal display device, etc. The present invention relates to a device for reducing dust-effects on an image suitable for these kinds of imaging apparatuses, and an image apparatus for example an imaging apparatus (an image taking apparatus) provided with the device for reducing dust-effects on an image.

2. Description of the Related Art

A so-called “lens interchangeable” digital camera is generally in practical use, which is provided with a photographing optical system removable from a camera body, so that users can remove and replace the photographing optical system with any desired one, thus enabling selective use of plural kinds of photographing optical systems for a single camera body. In such a lens interchangeable digital camera, when a photographing optical system is demounted from a camera body, dust could enter the inside of the camera from the outside through a mounting portion of the photographing optical system. In addition, since various mechanisms operating mechanically, such as, for example, shutter and aperture mechanisms, are arranged inside the camera body, material dust and the like could also be produced from these various mechanisms when they are in operation. Recently, the image quality of an image apparatus such as a digital camera has been greatly improved. Therefore, adhesion of dust to an optical element arranged in the optical path of an optical system for image formation in the image apparatus to cause casting of dust shadows on a formed image has been a big problem.

On the other hand, a liquid crystal projector is also in practical use, which enlargedly projects an image of a CRT (Cathode Ray Tube), a liquid crystal display device, or the like, onto a screen using a light source and a projection optical system for the purpose of picture viewing. In this case, adhesion of dust on the surface of the liquid crystal display device or the like could also cause shadows of dust to be projected onto the screen.

To remove such dust adhering to an optical element in an image apparatus such as the digital camera or the liquid crystal projector, various proposals have been made. A digital camera proposed in Japanese Patent Application Laid-Open No. 2002-204379 has a dust-proof member for sealing and protecting a photoelectric conversion surface side of an image pickup device to inhibit dust and the like from adhering to the photoelectric conversion surface of the image pickup device. Further, in this digital camera, vibration having a predetermined amplitude is given to the dust-proof member by an excitation mechanism to remove dust and the like adhering on the outer surface side of the dust-proof member. According to this related art, there can be configured a lens interchangeable type digital camera capable of inhibiting dust and the like from adhering to the photoelectric conversion surface of the image pickup device in a compact and simply mechanism while easily removing dust and the like adhering on the outer surface side of the dust-proof member.

An optical component is also proposed, in which a transparent conductive film is formed on the surface of the optical component, and a positive or negative potential is applied to the conductive film to remove dust charged to the same polarity (Japanese Patent Application Laid-Open No. 5-107405). There is further proposed a structure for providing an ionizer in a camera body to neutralize the surface charge on filters and the like provided between a photographing lens and a CCD (Charge Coupled Device) area sensor using ions generated by the ionizer in order to prevent dust from adhering to the filters and the like (Japanese Patent Application Laid-Open No. 2001-358974).

### BRIEF SUMMARY OF THE INVENTION

In the image apparatus of the present invention, ions generated by an ion generator are forcibly moved along a dust-proof member for protecting an image surface from dust to remove dust adhering to the surface of the dust-proof member.

An exemplary structure of the image apparatus of the present invention can comprise is as follows. An image apparatus comprises: an image surface on which the optical image is formed; a dust-proof member having a transparent portion in a region corresponding to the image surface, the transparent portion arranged to face the image surface with a predetermined space therebetween; an ion generator provided near the dust-proof member to generate negative or positive ions; and a transport part for moving ions generated by the ion generator along the surface of the dust-proof member.

The present invention can also be understood as an imaging apparatus, a device for reducing dust-effects on an image, and a dust removing method.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a partially cutaway perspective view schematically showing the internal mechanical structure of an electronic imaging apparatus (electronic camera) according to a preferred embodiment of the present invention;

FIG. 2 is a schematic block diagram primarily showing the electric structure of the electronic camera;

FIG. 3 is an exploded perspective view showing the main part of an imaging unit in the electronic camera;

FIG. 4 is a sectional view of the imaging unit in an assembled state;

FIGS. 5A to 5C are views showing an ion generator and components in the vicinity of the ion generator, where FIG. 5A is a front view, FIG. 5B and FIG. 5C are sectional views;

FIGS. 6A to 6D are views showing a dust removal operation using ion generation, where FIG. 6A shows a state upon start of voltage application, FIG. 6B shows the dust removal operation, FIG. 6C shows dust retention, and FIG. 6D shows a state upon stop of voltage application;

FIGS. 7A to 7D are views showing the dust removal operation continued from that shown in FIGS. 6A to 6D;

FIG. 8 is a view for explaining the effect of reducing the density of a dust shadow by means of a dust-proof filter, showing such a state that part of an image forming light beam of a photographing optical system is blocked by a speck of dust clinging to the dust-proof filter and hence the shadow of the dust speck is cast on an imaging surface;

FIGS. 9A and 9B are views for explaining the effect of reducing the density of the dust shadow by means of the dust-proof filter, where FIG. 9A shows a state of shadow X′ on the imaging surface when the dust-proof filter is in a stationary state, and FIG. 9B shows a state of shadow X′ on the imaging surface when the dust-proof filter is in a vibrating state;

FIG. 10 contains a front view as seen from the dust-proof filter side and a sectional view showing the main part of the imaging unit in the camera in an alternative example of the embodiment of the present invention;

FIG. 11 is a view for explaining the operation of a vibrating member and the dust-proof filter in the alternative example of the embodiment of the present invention;

FIG. 12 is a diagram for explaining a resonance frequency of the vibrating member, and vibration node and loop;

FIG. 13 is an electric circuit diagram showing the details of a dust-proof filter drive circuit and an ion generation control circuit;

FIG. 14 is a timing chart representing waveform signals related to the driving and operation of the dust-proof filter;

FIG. 15 is a flowchart showing a main routine in the embodiment of the present invention;

FIG. 16 is a flowchart showing a subroutine of ionizer dust-removing operation in the flowchart shown in FIG. 15;

FIG. 17 is a flowchart showing a subroutine of silent excitation operation in the flowchart shown in FIG. 15;

FIG. 18 is a graph representing a waveform pattern of resonance frequency continuously supplied to an excitation part;

FIG. 19 is a block diagram showing the details of the display part; and

FIGS. 20A to 20H are views representing display states of the display part.

### DETAILED DESCRIPTION OF THE PREFERRED EMBODIMENT

A preferred embodiment of the invention is described below with reference to the accompanying drawings.

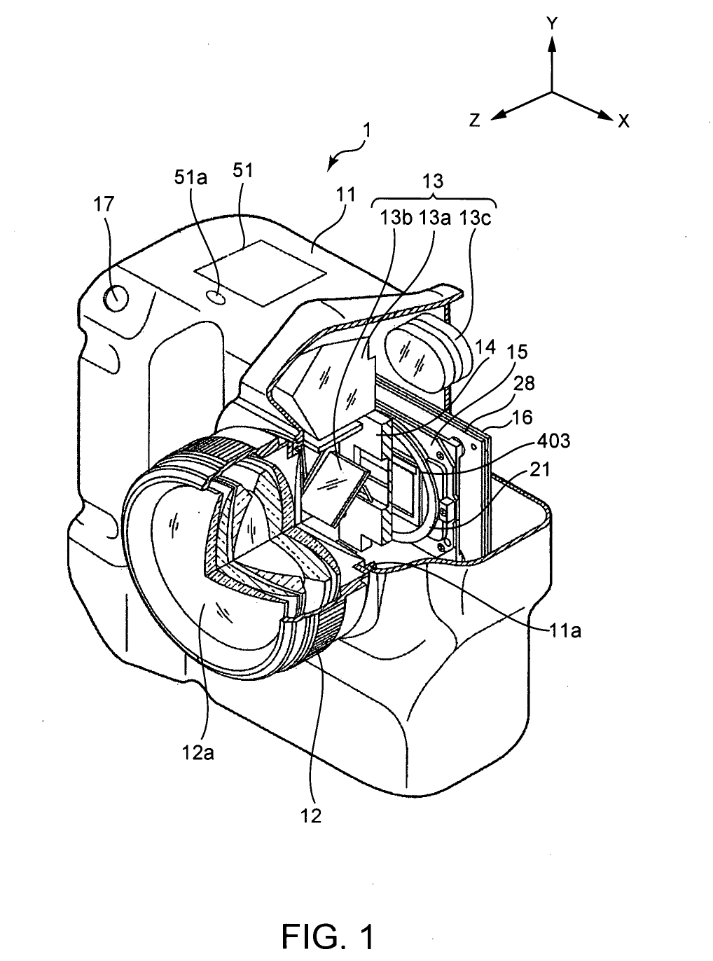

An image apparatus according to the present invention to be specifically illustrated below has a dust removing mechanism in an image pickup device unit for performing photoelectric conversion to acquire an image signal, the dust removing mechanism arranged between an optical system (such as a photographing lens) for image formation and a formed image. The dust removing mechanism removes dust from the optical element which dust can form a dust speck in an image if the dust specks thereto. Here, as an example, the present invention is explained as an improved technique for reducing the effects of dust on an image in an electronic camera (hereinafter simply referred to as “camera”). Specifically, a lens interchangeable single-lens reflex electronic camera (digital camera) is taken by way of example to describe a preferred embodiment with reference to FIGS. 1 to 20H.

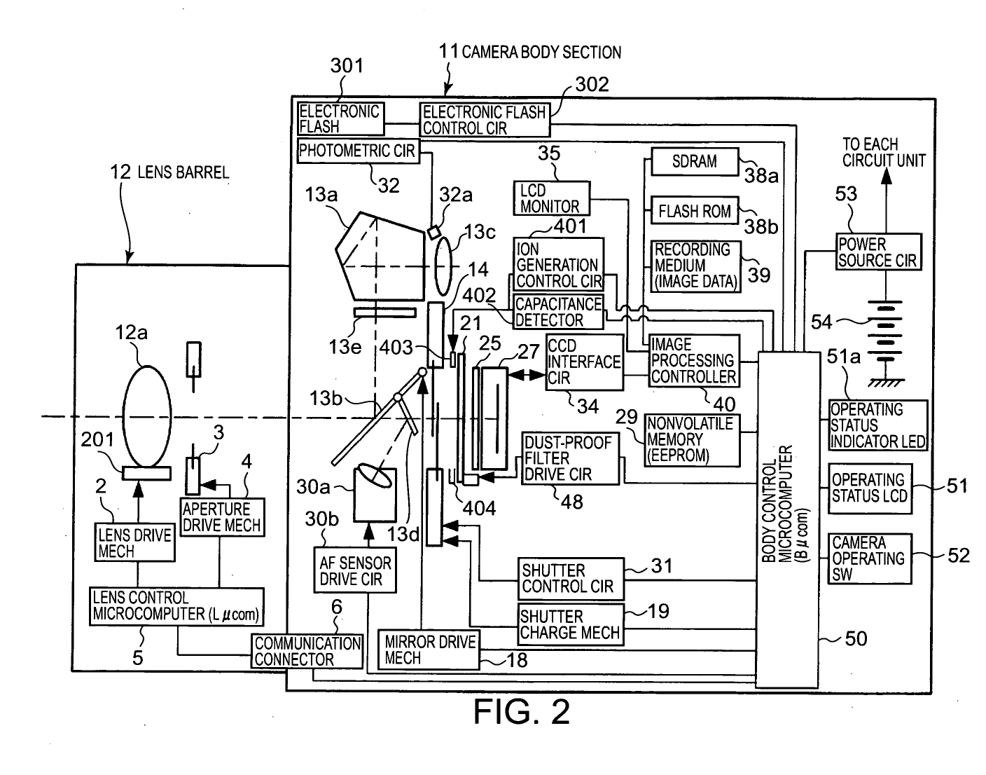

The schematic structure of the camera of the embodiment will first be described. FIGS. 1 and 2 show the structure of a camera 1 according to the embodiment. FIG. 1 is a partially cutaway perspective view schematically showing the internal mechanical structure of the camera 1, and FIG. 2 is a schematic block diagram primarily showing the electric structure of the camera 1.

Referring first to FIG. 1, the visual appearance and mechanical structure of the camera 1 will be described. The camera 1 according to the embodiment has a camera body section 11 and a lens barrel 12 constructed separately and removably from each other. Inside the lens barrel 12, a photographing optical system 12a having a plurality of lenses, a drive mechanism for the optical system, etc. are provided. This photographing optical system 12a consists, for example, of a plurality of optical lenses and the like, which allows a light flux from a subject to pass through to form a subject image from the subject light flux in a predetermined position (on a photoelectric conversion surface (light-receiving surface) of a CCD 27 as an image pickup device to be described later). The lens barrel 12 is mounted on the camera body section 11 to project from the front of the camera body section 11. Since the structure of this lens barrel 12 is the same as that generally used for conventional cameras and the like, the description thereof will be omitted here.

The camera body section 11 is provided with various component members therein and an optical system mounting part 11a on the front thereof as a connecting member for removably mounting the lens barrel 12 holding the photographing optical system 12a therein. The camera body section 11 is a so-called “single-lens reflex type” camera body. An exposure opening having a predetermined diameter to guide the subject light flux toward the inside of the camera body section 11 is formed in a substantially central portion of the front side of the camera body section 11, and the photographing optical system mounting part 11a is formed around the circumference of the exposure opening. The camera body section 11 also has a display part on the top outer surface thereof. The display part consists of an operating status indicator LED (Light Emitting Diode) 51a and/or an operating status LCD (Liquid Crystal Display) 51, etc. for showing not only the settings of exposure mode, shutter speed, aperture value, etc., but also the operating status of a dust-proof member to be described later.

On the outer surfaces of the camera body section 11, in addition to the above-mentioned photographing optical system mounting part 11a provided on the front face, various operating members are provided to operate the camera body section 11 in predetermined positions on the top and back faces. The operating members include, for example, a release button 17 for generating an instruction signal to start a shooting operation, and the like. Since these operating members are not directly related to the present invention, only the release button 17 is shown in FIG. 1 to simplify the drawing. The other operating members are not shown and their description is omitted here.

As shown in FIG. 1, various component members such as, for example, an imaging unit 15, a finder device 13, a shutter part 14, a plurality of circuit boards including a main circuit board 16 (only the main circuit board 16 is shown in FIG. 1), etc. are provided in predetermined positions, respectively, inside the camera body section 11.

The imaging unit 15 includes an image pickup device fixing plate 28, a CCD 27 as an image pickup device for photoelectrically converting a subject image formed through the photographing optical system 12a, a dust-proof filter 21 (to be described in detail later), etc. The image pickup device fixing plate 28 is to fix the CCD 27. The CCD 27 is an imaging part for acquiring an image signal corresponding to the subject image formed based on the subject light flux that has passed through the photographing optical system 12a and the shutter part 14. The dust-proof filter 21 is an optical element functioning as a dust-proof member for preventing dust and the like from adhering to the photoelectric conversion surface. The dust-proof filter 21 is arranged in a predetermined position in front of the photoelectric conversion surface of the CCD 27. The dust-proof filter 21 constitutes a filter part.

Further, inside the camera body section 11, an ion generator 403 is arranged between the shutter part 14 and the dust-proof filter 21 on the side of the shutter part 14 in the imaging unit 15. The ion generator 403 generates positive or negative ions to extinguish an electrically attracting force of charged dust adhering on the surface of the dust-proof filter 21 in order to remove dust. In the embodiment, the CCD 27 is used as the image pickup device, but the present invention is not limited thereto, and any other image pickup device can, of course, be used, such as a CMOS (Complementary Metal Oxide Semiconductor), as long as it can perform photoelectric conversion of the subject image to acquire an image signal.

The finder device 13 is a so-called “finder optical system” for producing the subject image formed through the photographing optical system 12a in a predetermined position different from the photoelectric conversion surface of the CCD 27. The finder device 13 consists of a reflecting mirror 13b configured to bend the optical axis of the subject light flux, which has passed through the photographing optical system 12a, and guide it toward the finder optical erect system side, a pentaprism 13a for receiving the light flux from the reflecting mirror 13b to form an erect-unreversed image, an eyepiece lens 13c for enlarging the image formed through the pentaprism 13a to produce an enlarged image best suited to viewing, etc. The reflecting mirror 13b is configured to be movable between a position retracted from the optical axis of the photographing optical system 12a and a predetermined position on this optical axis. In a normal state, the reflecting mirror 13b is arranged at a predetermined angle, for example, 45 degrees, with respect to the optical axis of the photographing optical system 12a. Therefore, when the camera 1 is in the normal state, the optical axis of the subject light flux passing through the photographing optical system 12a is bent by the reflecting mirror 13b and reflected toward the side of the pentaprism 13a arranged above the reflecting mirror 13b.

Then, in a shooting operation of the camera 1, the reflecting mirror 13b is moved to the predetermined position retracted from the optical axis of the photographing optical system 12a during an actual exposure operation. Therefore, the subject light flux is guided and irradiated to the CCD 27 to produce a subject image on the photoelectric conversion surface.

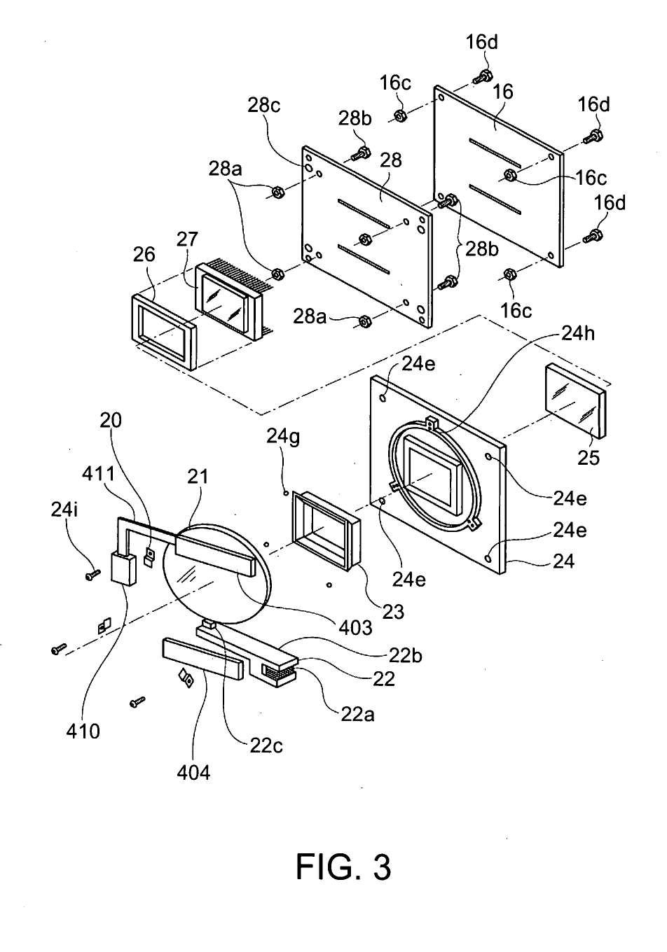

The shutter part 14 is equipped with a shutter mechanism and the like for opening or closing the optical path of the subject light flux to control the irradiation time of the subject light flux to the photoelectric conversion surface of the CCD 27 (see FIGS. 2 and 3), etc. The shutter part 14 includes, for example, a focal-plane type shutter mechanism, a driving circuit for controlling the operation of this shutter mechanism, etc, and adopts the same mechanism as generally used in conventional cameras. Therefore, the description of the detailed structure will be omitted here.

Mounted on the main circuit board 16 are various electric elements constituting electric circuits such as an image signal processing circuit for performing various signal processing on the image signal acquired by the CCD 27.

Referring next to the block diagram shown in FIG. 2, the camera system structure of the embodiment of the present invention will be described. This camera system has a system structure consisting of the camera body section 11, the lens barrel 12 that is an interchangeable lens as an accessory device (hereinafter simply referred to as “accessory”), etc. Note that, although the system structure can also include an external power source, an external electronic flash unit, and the like, loadable into or mountable on the camera body section 11, but their description will be omitted here.

A lens barrel 12 desired by a user is removably mounted on the front side of the camera body section 11 through the photographing optical system mounting part 11a. Then, a recording medium 39, which is any one of various external recording media such as a memory card loadable into the camera body section 11 or an external HDD, is connected through a communication connector (not shown) in such a manner to be able to communicate with the camera body section 11 and being replaceable with another.

The lens barrel 12 is controlled by a lens control microcomputer (hereinafter abbreviated as “L μcom”) 5. The camera body section 11 is controlled by a body control microcomputer (hereinafter abbreviated as “B μcom”) 50. When the lens barrel 12 is mounted on the camera body section 11, the L μcom 5 and the B μcom 50 are electrically connected through a communication connector 6. The L μcom 5 cooperates dependently with the B μcom 50 to operate in the camera system. Inside the lens barrel 12, the photographing optical system 12a, a lens frame 201 for holding the photographing optical system, and an aperture 3 are provided. The photographing optical system 12a is driven by a DC motor (not shown) provided inside a lens drive mechanism 2. The aperture 3 is driven by a stepping motor (not shown) provided inside an aperture drive mechanism 4. The L μcom 5 controls the respective motors in accordance with instructions from the B μcom 50.

As shown, the following component members are arranged inside the camera body section 11. For example, single-lens reflex type component members as the optical system (the pentaprism 13a, the reflecting mirror 13b, the eyepiece lens 13c, a sub-mirror 13d, and a focusing screen 13e), the focal-plane shutter part 14 arranged on the optical axis, and an AF sensor unit 30a for receiving a light flux reflected from the sub-mirror 13d to perform auto focusing. Further, an AF sensor drive circuit 30b, a mirror drive mechanism 18, a shutter charge mechanism 19, a shutter control circuit 31, and a photometric circuit 32 are provided. The AF sensor drive circuit 30b controls the driving of the AF sensor unit 30a. The mirror drive mechanism 18 controls the driving of the reflecting mirror 13b. The shutter charge mechanism 19 charges a spring for driving front and rear curtains of the shutter part 14. The shutter control circuit 31 controls the traveling of the shutter front and rear curtains. The photometric circuit 32 measures the subject brightness and the like based on the output of a photometric sensor 32a for receiving the light flux from the pentaprism 13a.

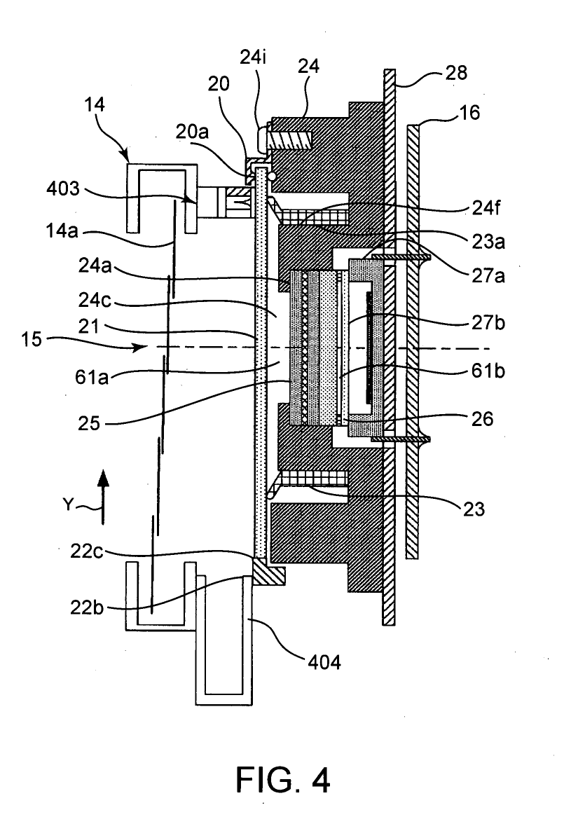

The CCD 27 is provided on the optical axis of the photographing optical system 12a to photoelectrically convert the subject image that has passed through the optical system. The dust-proof filter 21 as an optical element is provided between this CCD 27 and the photographing optical system 12a to protect the CCD 27. In a peripheral portion of the dust-proof filter 21, for example, a vibrating member 22 as part of an excitation part for vibrating the dust-proof filter 21 at a predetermined frequency is attached (see FIGS. 3 and 4). The vibrating member 22 is configured to be able to apply a frequency voltage to vibrate the dust-proof filter 21 through a dust-proof filter drive circuit 48 as part of the excitation part in order to remove dust adhering to the filter surface or reduce the density of the shadows of dust clinging to the filter surface and hence incapable of being removed by vibration. Thus, this camera system is an electronic camera having a basic structure belonging in a category of so-called “dust-proof camera.” Note that a thermometric circuit (not shown) is provided near the dust-proof filter 21 to measure ambient temperature around the CCD 27. Further, ion generation circuit 401, an ion generator 403, and a dust collecting box 404 are provided in order to remove dust adhering to the dust-proof filter 21, which will be described in detail later.

This camera system is further provided with a CCD interface circuit 34 connected to the CCD 27, an LCD monitor 35, and an image processing controller 40. Thus, the camera system is configured to provide an electronic recording/display function as well as an electronic imaging function. The image processing controller 40 performs image processing using an SDRAM 38a, a flash ROM 38b and a recording medium 39, etc. provided as memory areas. Further, as still another storage area for storing predetermined control parameters necessary for camera control, a nonvolatile memory 29 such as an EEPROM is provided accessibly from the B μcom 50.

The operating status LCD 51 and the operating status indicator LED 51a for showing the operating status of the camera 1 to the user, and a camera operating switch part 52 (hereinafter abbreviated as “SW”) to be described later are connected to the B μcom 50. The operating status indicator LED 51a indicates the operating state of a dust-proofing function such as the dust-proof filter drive circuit 48 or an ion generation control circuit 401 while the dust-proofing function is in operation. The camera operating SW 52 is a switch group including operation buttons necessary to operate the camera 1 such as, for example, a release SW, a mode change SW, a power SW, etc. Further, a battery 54 as a power source and a power source circuit 53 for converting the voltage of the power source and supplying a voltage necessary for each circuit unit of the camera system are provided. If the camera system is configured to be supplied with power from an external power source through a jack or the like, a voltage detection circuit can also be provided for detecting a change in voltage. An built-in electronic flash 301 includes a flash strobe tube (not shown) and a DC/DC converter (not shown), and is connected to an electronic flash control circuit 302 to emit flash light in response to a control signal from the B μcom 50.

Each component of the camera system configured as mentioned above operates as follows. First, the image processing controller 40 controls the CCD interface circuit 34 in accordance with instructions from the B μcom 50 to acquire image data from the CCD 27. The image data is converted to a video signal through the image processing controller 40 and output to and displayed on the LCD monitor 35. This allows the user to check the shot image from the display image on the LCD monitor 35. The SDRAM 38a is a memory for temporary storage of image data and is used as a working area upon conversion of image data and the like. After converted to JPEG data, the image data is stored on the recording medium 39.

The CCD 27 is protected by the transparent dust-proof filter 21. The vibrating member 22 for vibrating the filter surface is arranged around the periphery of this dust-proof filter 21, and is driven by the dust-proof filter drive circuit 48 serving also as a drive part. In order to reduce the effects of dust, it is preferable that the CCD 27 be integrally housed in a case with the dust-proof filter 21 as its one side. In general, temperature affects the elastic coefficient of the vibrating member 22. Since temperature is one factor that varies the natural frequency of the vibrating member 22, the temperature needs to be measured while the vibrating member 22 is in operation to take its natural frequency into account. In this case, a sensor (not shown) connected to a thermometric circuit is provided to measure ambient temperature around the CCD 27. It is preferable that the temperature measuring points of the sensor be set very close to both poles of the vibrating member 22.

The mirror drive mechanism 18 is a mechanism for driving the reflecting mirror 13b between a raised (UP) position and a lowered (DOWN) position. When this reflecting mirror 13b is at the DOWN position, the light flux from the photographing optical system 12a is divided and guided to the AF sensor unit 30a and the pentaprism 13a, respectively. The output of an AF sensor in the AF sensor unit 30a is sent to the B μcom 50 through an AF sensor drive circuit 30b, and known distance measurement processing is performed. while the user can view the subject through the eyepiece lens 13c, part of the light flux that has passed through the pentaprism 13a is guided to the photometric sensor 32a in the photometric circuit 32, and known photometric processing is performed based on the amount of light detected.

The following describes the detailed structure of the imaging unit 15 of the embodiment consisting of the shutter part 14, the shutter charge mechanism 19, the CCD 27, a optical low-pass filter 25, the dust-proof filter 21, etc. FIG. 3 is an exploded perspective view of the main part of the imaging unit 15 in the camera 1 of the embodiment. FIG. 4 is a sectional view of the imaging unit 15 in an assembled state taken along a cross-section including Y and Z axes (where Z axis coincides with the optical axis of the lens) in FIG. 1. As mentioned above, although the imaging unit 15 in the camera 1 of the embodiment is a unit consisting of a plurality of members including the CCD 27, only the main part is shown in FIGS. 3 and 4. Further, in order to show the positional relationship among respective component members, the main circuit board 16 on which imaging system electric circuits consisting of the image signal processing circuit, the working memory, etc. are mounted is also shown in FIGS. 3 and 4. It is assumed here that a circuit board generally used in conventional cameras is adopted for this main circuit board 16. Therefore, the detailed description thereof will be omitted.

The imaging unit 15 includes the CCD 27, the image pickup device fixing plate 28, the optical low-pass filter (hereinafter referred to as “optical LPF”) 25, and a low-pass filter receiving member 26. The CCD 27 acquires an image signal corresponding to light passing through the photographing optical system 12a and irradiated on its photoelectric conversion surface. The image pickup device fixing plate 28 is a thin plate-shaped member for fixing and supporting this CCD 27. The optical LPF 25 is arranged on the side of the photoelectric conversion surface of the CCD 27 to remove high frequency components from the subject light flux passing through the photographing optical system 12a and irradiated on the photoelectric conversion surface. The low-pass filter receiving member 26, formed into a substantially frame-shaped elastic member or the like, is arranged around the periphery between the optical LPF 25 and the CCD 27.

The imaging unit 15 also includes an image pickup device storage case member 24 (hereinafter referred to as “CCD case 24”), and a dust-proof filter receiving member 23. The CCD case 24 is fastened with screws to the image pickup device fixing plate 28 for fixing and supporting the CCD 27 to fix and support the optical LPF 25 sandwiched between the CCD case 24 and the CCD 27 through the low-pass filter receiving member 26. The dust-proof filter receiving member 23 is arranged on the front side of this CCD case 24 in such a manner that one opening portion is attached closely to the dust-proof filter 21 as the dust-proof member and the other opening portion is attached closely to an external wall of a rectangular opening portion of the CCD case 24 to hermetically seal the space sandwiched between the optical LPF 25 and the dust-proof filter 21.

The imaging unit 15 further includes balls 24g, a pressing member 20, and the dust-proof filter 21. The balls 24g are held in hemispheroidal depressed portions 24h provided in the CCD case 24. The pressing member 20 presses the dust-proof filter 21 on the balls 24g by means of hemispheroidal protrusions 20a. The dust-proof filter 21 is the dust-proof member arranged in a predetermined position on the side of the photoelectric conversion surface of the CCD 27 in front of the optical LPF 25 to face the optical LPF 25 with a predetermined space through the balls 24g.

Furthermore, the imaging unit 15 includes the vibrating member 22, the dust-proof filter drive circuit 48 (see FIG. 2) as a drive circuit for driving this vibrating member 22, etc. The vibrating member 22 is an excitation member as the excitation part arranged around the periphery of the dust-proof filter 21 to apply vibration to the dust-proof filter 21. The vibrating member 22 is configured such that an electromechanical conversion element 22a is firmly fixed to an elastic body 22b made of aluminum, stainless steel, or the like, having a small vibration damping property, and a protrusion 22c is firmly fixed to the dust-proof filter 21.

The CCD 27 as the imaging part for receiving the subject light flux passing through the photographing optical system 12a on its photoelectric conversion surface to perform photoelectric conversion processing. The CCD 27 is mounted in a predetermined position on the main circuit board 16 through the image pickup device fixing plate 28. As mentioned above, the image signal processing circuit, the working memory, etc. are also mounted on this main circuit board 16 to process the output signal from the CCD 27, i.e., the image signal obtained by the photoelectric conversion processing. A rectangular opening 24c is provided in a substantially central portion of the CCD case 24, and the optical LPF 25 and the CCD 27 are arranged behind the opening 24c. As mentioned above, the low-pass filter receiving member 26 made of an elastic member or the like is arranged between the optical LPF 25 and the CCD 27. This low-pass filter receiving member 26 is arranged in a position, which falls beyond the effective range of the photoelectric conversion surface, around the periphery of the front side of the CCD 27, and brought into contact with the vicinity of the periphery of the back side of the optical LPF 25. The space between the optical LPF 25 and the CCD 27 is held substantially airtight. This causes the low-pass filter receiving member 26 to exert an elastic force on the optical LPF 25 in the optical axis direction.

The optical LPF 25 is so arranged that the periphery of the front side thereof will come in contact with a step portion 24a of the CCD case 24 in a substantially airtight manner. Therefore, the position of the optical LPF 25 in the optical axis direction is restricted against the elastic force of the low-pass filter receiving member 26 to displace the optical LPF 25 in the optical axis direction. In other words, the optical LPF 25 inserted into the opening 24c of the CCD case 24 from the back side is restricted in position in the optical axis direction by the step portion 24a. This ensures that the optical LPF 25 does not get out of the inside of the CCD case 24 toward the front side thereof. Here, an annular sheet made of an elastic material similar to that of the low-pass filter receiving member 26 can be sandwiched between the step portion 24a of the CCD case 24 and the periphery of the front side of the optical LPF 25 to improve airtightness.

After the optical LPF 25 is thus inserted into the opening 24c of the CCD case 24 from the back side, the CCD 27 is arranged on the back side of the optical LPF 25. The low-pass filter receiving member 26 is sandwiched around the periphery between the optical LPF 25 and the CCD 27. Further, as mentioned above, the CCD 27 is mounted on the main circuit board 16 through the image pickup device fixing plate 28. Then, the image pickup device fixing plate 28 is secured on the CCD case 24 through spacers 28a by screwing screws 28b into screw holes 24e from the back side of the CCD case 24. Although the spacers 28a are not necessarily required, they are effective in keeping airtightness even if the members sandwiched between the image pickup device fixing plate 28 and the CCD case 24 vary in size. Further, the main circuit board 16 is fastened to the image pickup device fixing plate 28 with screws 16d through spacers 16c. Further, the image pickup device fixing plate 28 is fixed to the camera body section through spacers (not shown) for adjusting the mounting position and inclination thereof in the optical axis direction by screwing screws (not shown) into screw holes (not shown) of the camera body section through screw holes 28c.

A back-end rectangular opening 23a of the dust-proof filter receiving member 23 is fitted in and fixed to a front-side outer peripheral opening 24f provided on the front side of the CCD case 24. The back-end rectangular opening 23a of the dust-proof filter receiving member 23 is formed smaller than the rectangle of the front-side outer peripheral opening 24f of the CCD case 24, and the dust-proof filter receiving member 23 having rubber elasticity is elastically deformed and fitted in the front-side outer peripheral opening 24f. On the other hand, a front-side opening of the dust-proof filter receiving member 23 is formed to be wider toward the front end so that the front end thereof will be elastically deformed and come in contact with the backside of the dust-proof filter 21 in the assembled state. This ensures that the space surrounded by the dust-proof filter 21 and the optical low-pass filter is hermetically closed.

The dust-proof filter 21 has a circular or polygonal plate-like shape as a whole, and at least a region radially expanded from the center thereof is formed into a transparent portion. Then, the transparent portion is arranged to face the front side of the optical LPF 25 with a certain space therebetween. In other words, this transparent portion is arranged to face a region corresponding to the photoelectric conversion surface as an image surface. Further, the vibrating member 22 is firmly fixed in a peripheral portion of the dust-proof filter 21 to apply vibration to the dust-proof filter 21. This vibrating member 22 is a certain excitation member in which the electromechanical conversion element 22a is integrally fixed to the elastic body 22b. This electromechanical conversion element 22a is provided, for example, using an adhesive agent or the like. On the other hand, the protrusion 22c is firmly fixed to one end of the vibrating member 22, while the other end of the vibrating member 22 is firmly fixed to the CCD case 24 with a viscoelastic adhesive agent not to dampen vibration to the protrusion 22c. Then, the protrusion 22c is firmly fixed to the dust-proof filter 21.

A drive voltage having a predetermined cycle is applied to this electromechanical conversion element 22a by a dust-proof filter drive part (not shown) so that predetermined vibration, i.e., standing-wave vibration can be generated in the elastic body 22b provided integrally with the fixed dust-proof filter 21. Note here that the protrusion 22c is positioned in the neighborhood of a loop (corresponding to the position of the maximum amplitude) of the standing-wave vibration. The generated standing wave vibrates substantially in a Y-axis direction in the dust-proof filter plane (see FIG. 4). Here, if the frequency of the drive voltage applied to the electromechanical conversion element 22a is set to a frequency at which the vibrating member 22 with the dust-proof filter 21 fixed thereto resonates, the generated vibration amplitude will be tens to hundreds of times the non-resonant vibration. Therefore, the effect of removing dust adhering to the dust-proof filter by an inertia force caused by vibration becomes very large. Further, even if dust particles cling to the dust-proof filter and incapable of being removed by vibration, the density of shadows of the dust particles cast on the CCD 27 can be reduced (the details will be described later), thereby making it possible to reduce the chances of casting the shadows of dust clinging to the dust-proof filter on a shot image.

The dust-proof filter receiving member 23 and the CCD case 24 are fit together substantially in an airtight condition as mentioned above, while the dust-proof filter receiving member 23 and the dust-proof filter 21 are joined together in an airtight condition by an urging force of the pressing member 20. Further, the optical LPF 25 arranged in the CCD case 24 is so arranged that the space between the periphery of the front side of the optical LPF 25 and the step portion 24a of the CCD case 24 will be substantially airtight. Further, the CCD 27 is arranged on the backside of the optical LPF 25 through the low-pass filter receiving member 26, and substantial airtightness is also kept between the optical LPF 25 and the CCD 27. Thus, a predetermined air gap portion 61a is formed in a space between the optical LPF 25 and the dust-proof filter 21 to face each other. A space portion 61b is also formed between the optical LPF 25 and the CCD 27 to face each other. These air gap portion 61a and space portion 61b are tightly sealed spaces. Since no dust enters the sealed spaces 61a and 61b from the outside, dust adheres only to the surface of the dust-proof filter 21 on the side of the photographing optical system 12a between the photoelectric conversion surface of the CCD 27 and the photographing optical system 12a. Of course, the photoelectric conversion surface is hermetically sealed by an image pickup device package 27a and a cover glass 27b, so that no dust from the outside adheres thereto.

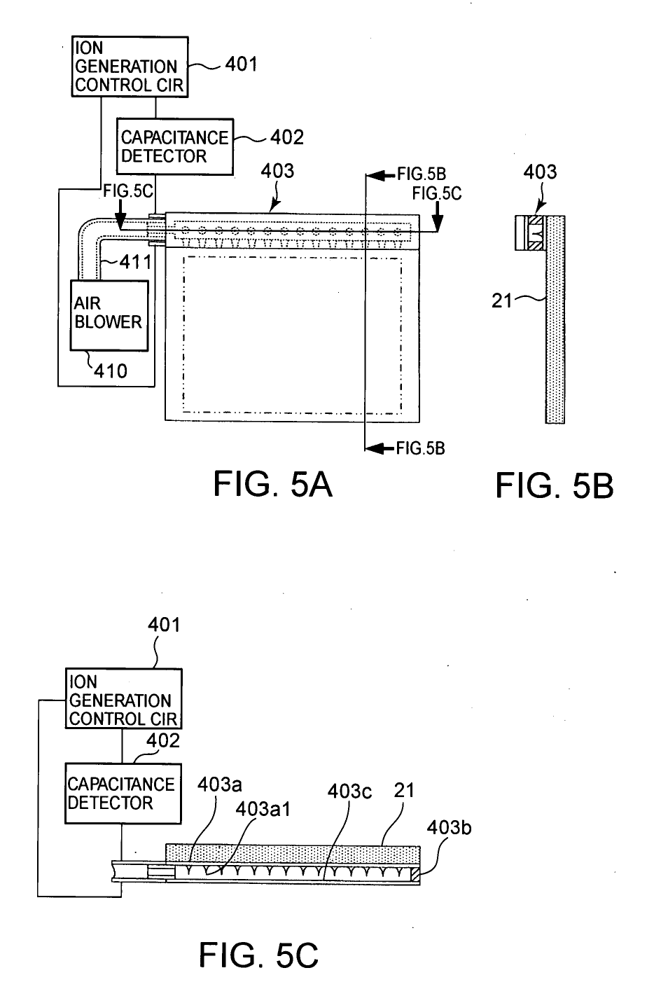

The following describes a dust-proof mechanism using positive or negative ions. The ion generator 403 having an elongate shape is provided in a fixed condition above an area of the dust-proof filter 21 corresponding to a shooting screen. The ion generator 403 is coupled to an air blower 410 through a pipe-like draft duct 411. Since a flow of air blows out from this air blower 410 toward the ion generator 403, the air flows from the ion generator 403 from top down along the surface of the filter 21. Further, the dust collecting box (dust collecting part) 404 is arranged at a position on the bottom side of the dust-proof filter 21 and opposite to the ion generator 403. A voltage having a reversed polarity to that of the voltage applied to the ion generator 403 is applied to the dust collecting box 404 in a manner to be described later to electrically attract generated ions. Further, a sticky material 404a made of an adhesive material is pasted on the inner faces of the dust collecting box 404 to anchor dust. As shown in FIG. 4, the ion generator 403 and the dust collecting box 404 are sandwiched between the dust-proof filter 21 and the shutter 14. A shutter curtain 14a of this shutter 14 and the dust-proof filter 21 form a narrow space in which the ions generated by the ion generator 403 move in a manner to be described later. Thus, the shutter curtain 14a spaced away from the dust-proof filter 21 functions as a guide member for regulating the flow of ions. Then, transparent electrodes are formed on the surface of the dust-proof filter 21 and connected to the same ground as a facing electrode substrate 403c (see FIG. 5C).

Thus, in the embodiment, the air blower 410, the draft duct 411, the shutter curtain 14a, and the dust collecting box 404 are elements of a transport part for moving the ions along the dust-proof filter 21. The ions can be moved by the airflow from the air blower 410, and moved into the dust collecting box 404 by the application of voltage having a reverse polarity of potential to that of the ions generated from the ion generator 403. Therefore, all of the above-mentioned elements is not necessarily provided as the elements of the transport part. For example, the combination of elements can be changed arbitrarily such as to provide only the air blower 410 or only the dust collecting box 404.

FIG. 5A shows a front view of the ion generator 403, and FIGS. 5B and 5C show sectional views of the ion generator 403. As mentioned above, the ion generator 403 is arranged in an upper portion of the dust-proof filter 21. This ion generator 403 has electrodes 403a1 for applying a frequency potential, the facing electrode substrate 403c connected to the circuit earth, and an insulated spacer 403b inserted between an electrode substrate 403a and the facing electrode substrate 403c. Further, a capacitance detector 402 is electrically connected to the ion generation control circuit 401 between the electrode substrate 403a and the facing electrode substrate 403c. The ion generation control circuit 401 is a circuit for controlling voltage applied to the electrodes 403a1. The capacitance detector 402 is a circuit for detecting a capacitance in the ion generating space before generation of the ions. The capacitance detector 402 applies such a low level of frequency voltage not to generate ions at each of the electrodes 403a1 to measure the magnitude of current flowing between the electrodes 403a1 and the facing electrode substrate 403c, thus detecting the capacitance. Upon generation of ions, a frequency voltage having a voltage and frequency for generating optimum corona discharge, predetermined according to the current value detected by the capacitance detector 402, is applied to the electrodes 403a1 to generate corona discharge in order to ionize gas or minute dust particles present in the ion generating space.

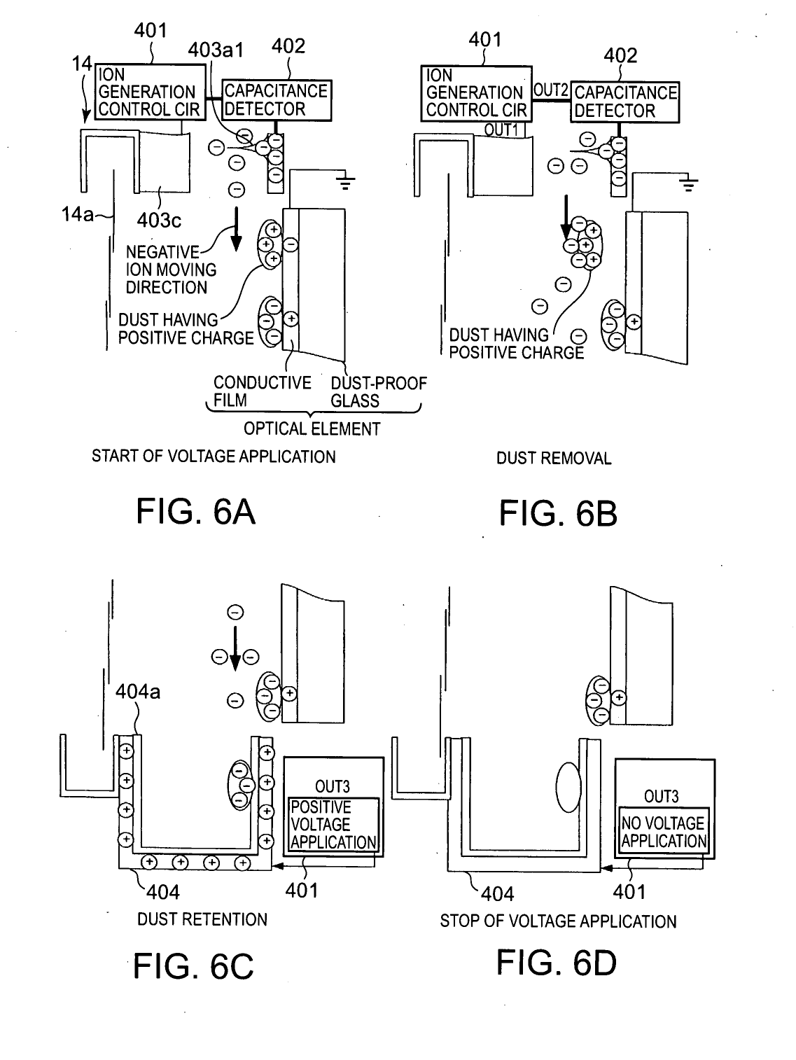

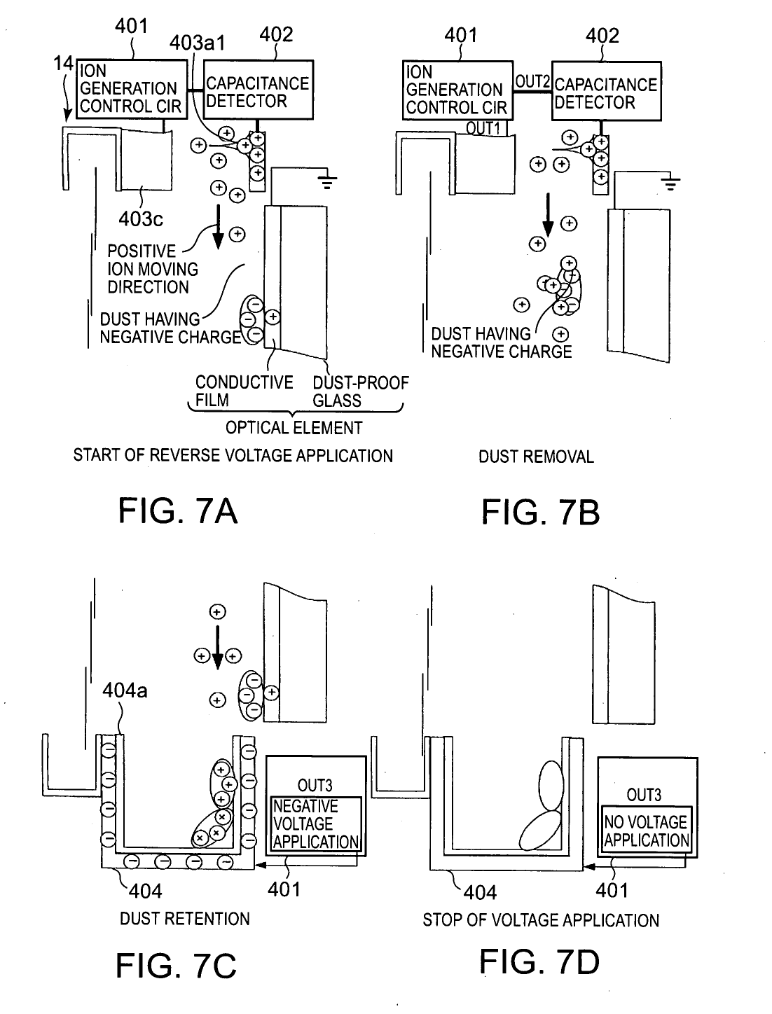

Referring next to FIGS. 6A to 6D, and FIGS. 7A to 7D, the operation of this ion generator 403 will be described. As discussed above, the capacitance detector 402 detects the capacitance in the ion generating space prior to ion generation, and based on the detection result, a negative frequency voltage is applied to the electrodes 403a1. Therefore, negative ions are generated around the electrodes 403a1, and attracted by the voltage applied to the dust collecting box 404, which voltage is supplied from an output terminal OUT3 of the ion generation control circuit 401. Further, the ions are also moved by the airflow from the air blower 410 along the surface of the dust-proof filter 21 (see FIG. 6A).

The negative ions neutralize surface charges of dust particles adhering to the dust-proof filter 21 by an electrically attractive force (an attractive force between the electric charges of the dust and electric charges induced by the electric charges of the dust) to cancel the electric attractive force in order to carry the dust in the ion moving direction (see FIG. 6B). The air flowing from the air blower 410 is not all ionized, and only the air passing by the electrodes 403a1 upon the application of the voltage is ionized. Note that the air already positively ionized before passing through the ion generator 403 is neutralized or negatively ionized through the ion generator 403.

The dust particles neutralized by the negative ions or negatively ionized move down the surface of the dust-proof filter 21 through the airflow, and since the dust collecting box 404 provided at the position opposite to the ion generator 403 is charged to a positive potential, the dust particles are absorbed into the dust collecting box 404 (see FIG. 6C). Further, since the sticky material 404a is coated inside the dust collecting box 404, the dust particles remain held in the dust collecting box 404 even if the application of the voltage to the dust collecting box 404 is stopped (see FIG. 6D).

Thus, the negative ions generated by the ion generator 403 moves in the space between the dust-proof filter 21 and the shutter curtain 14a and flows toward the dust collecting box 404 while being attracted by the voltage applied to the dust collecting box 404 through the airflow blown out from the air blower 410. Then, the positively charged dust particles adhering to the surface of the dust-proof filter 21 can be electrically neutralized and removed.

Although the above describes the case where negative ions are generated by the ion generator 403, the same holds true with respect to a case where positive ions are generated by the ion generator 403. In other words, if a positive voltage is applied to the electrodes 403a to generate positive corona discharge, electrons are pulled out of air or dust, making it possible to generate positively ionized air (see FIG. 7A). Then, the positive ions are flown along the surface of the dust-proof filter 21, electrically coupled to negative charges of dust particles adhering to the surface of the dust-proof filter 21 by an electric attractive force of the negative charges, and electrically neutralized so that the electric attractive force will be cancelled, thereby making it possible to remove the dust particles from the surface of the dust-proof filter 21 (see FIG. 7B). At this time, since the dust collecting box 404 is applied with a negative potential, the positive ions are attracted together with the dust particles toward the side of the dust collecting box 404 (see FIG. 7C). The dust particles attracted into the dust collecting box 404 are held by the sticking material 404a (see FIG. 7D). Thus, the positive ions generated by the ion generator 403 flows in the space between the dust-proof filter 21 and the shutter curtain 14a through the airflow blown out by the air blower 410, so that the dust particles adhering to the surface of the dust-proof filter 21 and having negative surface charges can be electrically neutralized and removed.

In the embodiment, in addition to the dust-proof mechanism using ions in the manner as mentioned above, a dust removing mechanism using the vibrating member 22 is also provided. The dust-proof mechanism using static charges and the dust-proof mechanism using vibration can be operated concurrently, or at different timings. Note that if both are operated concurrently, the dust removing effect is enormously increased.

Next, the operation of reducing dust-effects will be described in detail. As discussed above, the dust adhering to the surface of the dust-proof filter 21 can be removed by the vibrating member 22 vibrating the dust-proof filter 21. On the other hand, as for the dust clinging to the dust-proof filter 21 and incapable of being removed by vibration, the density of shadows of dust cast on the imaging surface can be reduced by vibrating the dust-proof filter 21 in the Y-axis direction during exposure. This can reduce the density of the shadows of the dust particles cast on the imaging surface to such a level, for example, not to be recorded in a shot image.

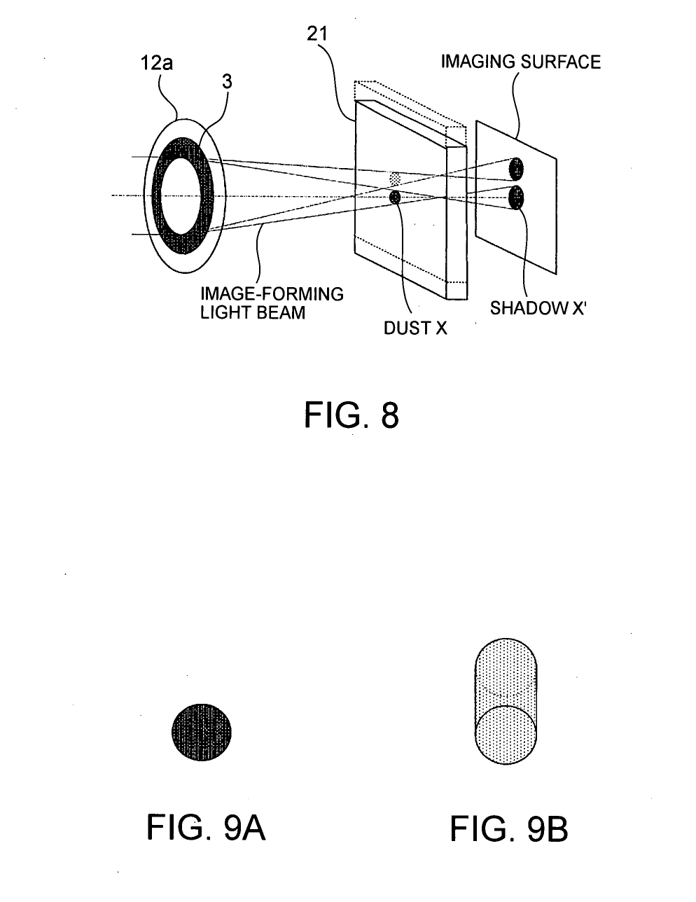

This effect of reducing the density of shadows of the dust particles using the dust-proof filter 21 is shown in FIGS. 8 and 9. FIG. 8 shows a state where part of the imaging light beam of the photographing optical system 12a is blocked by dust X clinging on the dust-proof filter 21 and hence a shadow image X′ is formed on the imaging surface. In this condition, if the dust-proof filter 21 vibrates up and down (in the Y-axis direction in FIG. 4), the shadow image X′ also vibrates up and down. If the shadow vibrates with an amplitude larger than the size of the shadow during exposure with the camera, the density of the shadow can be reduced to about one-half or less of that for no-vibration case, thereby reducing or improving dust-effects on an image.

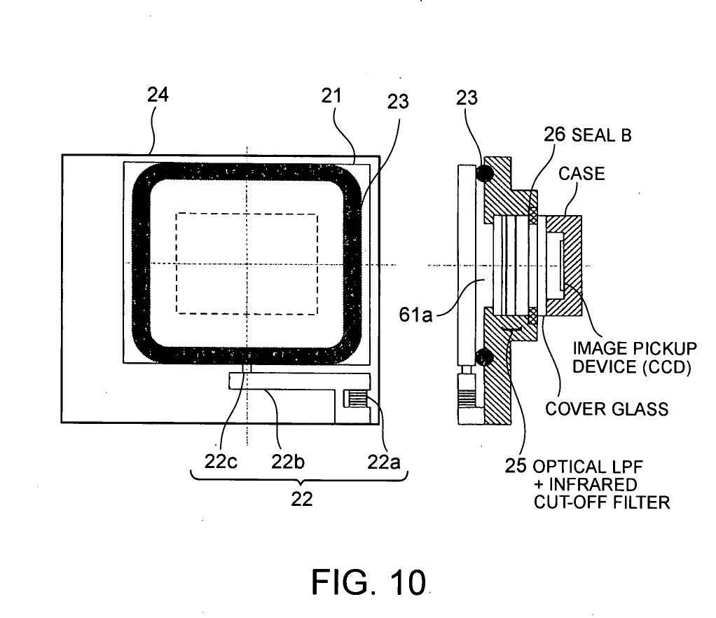

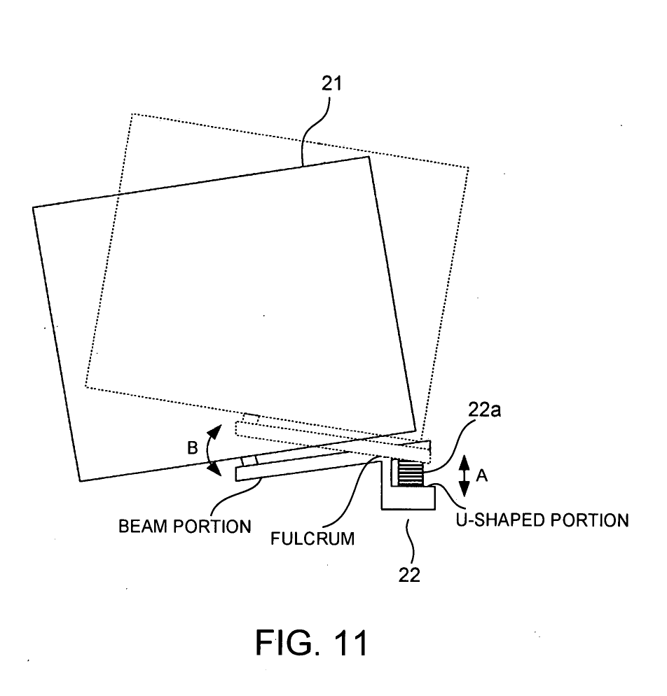

FIGS. 10 and 11 show an alternative example of the embodiment. FIG. 10 contains a front view and a sectional view of the main part of the alternative example corresponding to part of the components in FIG. 4. Different points from the embodiment are that firstly the shape of the dust-proof filter is a rectangular, and secondly the structure for supporting the dust-proof filter 21 is different. In the alternative example, as shown in FIG. 10, the dust-proof filter 21 is directly supported by the dust-proof filter receiving member 23 as a rectangular, annular-shaped elastic member (e.g., rubber) having a circular shape in cross-section in such a manner that the space 61a will be hermetically sealed by the dust-proof filter receiving member 23.

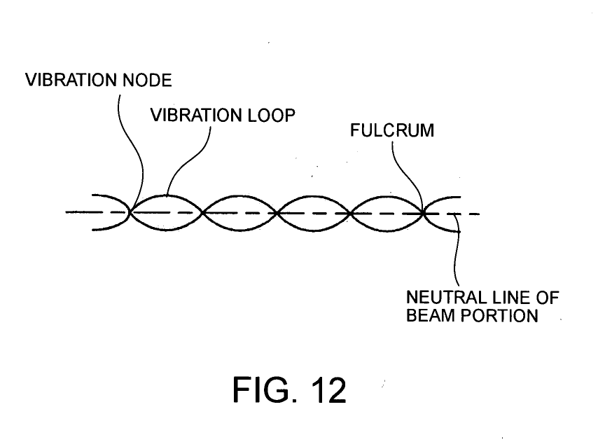

FIG. 11 shows only the dust-proof filter 21 and the vibrating member 22 for explaining the operation of the vibrating member 22 and the dust-proof filter 21. Here, the electromechanical conversion element 22a consists of laminated piezoelectric substances, and when a predetermined frequency voltage is applied to the piezoelectric substances, they expand and contract in a direction indicated by double-headed arrow A. Since the electromechanical conversion element 22a is firmly fixed in a U-shape portion of the elastic body 22b, a beam portion of the elastic body 22b vibrates in B direction along an arc about a fulcrum. Further, if the frequency of the frequency voltage is set to a natural vibration frequency (resonance frequency) of the system in which the dust-proof filter 21 is firmly fixed to the vibrating member 22, vibration in the B direction is increased to tens or hundreds of times of the case of applying an electric signal the frequency of which is not the resonance frequency. The resonance frequency generated can vary from first-order to higher-order (see FIG. 12). In case of a higher-order resonance frequency, the beam vibration becomes bending vibration having a plurality of nodes along the beam portion. In this case, if the place at which the protrusion is provided is set to a loop (corresponding to the position of the maximum amplitude) of the bending vibration, it is possible to vibrate the dust-proof filter 21 with large amplitude. Specifically, if it is not to be resonated, the amplitude is several μm, while if it is to be resonated, the amplitude becomes several tens of μm or exceeds 0.1 mm. Since the amplitude is 0.1 mm level at most, the vibration is not transmitted to the other members because the rubber deforms even if the elastic member directly receives the dust-proof filter 21 as shown in FIG. 10, thus making it possible to vibrate the dust-proof filter 21 efficiently.

Then, under this condition, a periodic voltage is applied to the electromechanical conversion element 22a to vibrate the dust-proof filter 21 in order to remove dust and the like adhering to the surface of the dust-proof filter 21. Further, since the dust-proof filter 21 is vibrated in an in-plane direction, the density of shadows of dust clinging to the dust-proof filter 21 can be reduced as shown in FIGS. 8 and 9. At this time, if the vibration frequency is set in an ultrasonic range, the dust-proof mechanism using vibration can be more effective. This is because if the dust-proof filter 21 is vibrated in the ultrasonic range, the inertia force applied to the dust can be increased, and hence the effect as shown in FIGS. 8 and 9 can be achieved even when the camera is set to a faster shutter speed. To be more specific, if the vibration is 20 kHz, the dust-proof filter 21 vibrates twice even when the shutter is actuated with a shutter speed of 1/10000 second, and this makes it possible to fully demonstrate the effect of reducing the density of dust shadows. Since this dust-proof mechanism using vibration is totally different from the above-mentioned dust-proof mechanism using ions in terms of the method of removing dust, both can be used in combination to effectively remove dust.

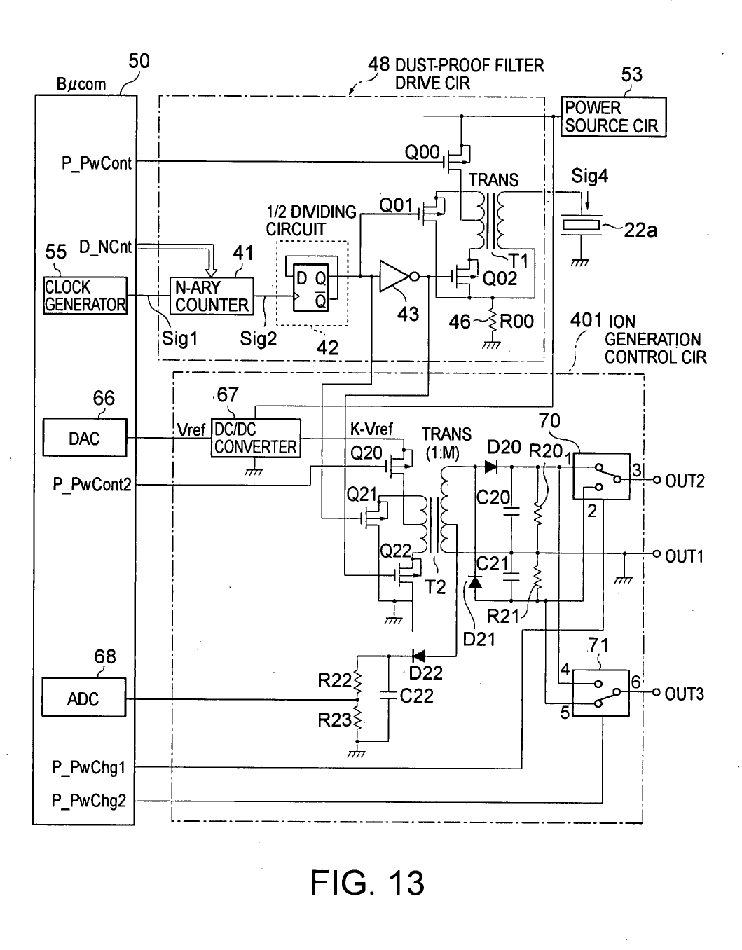

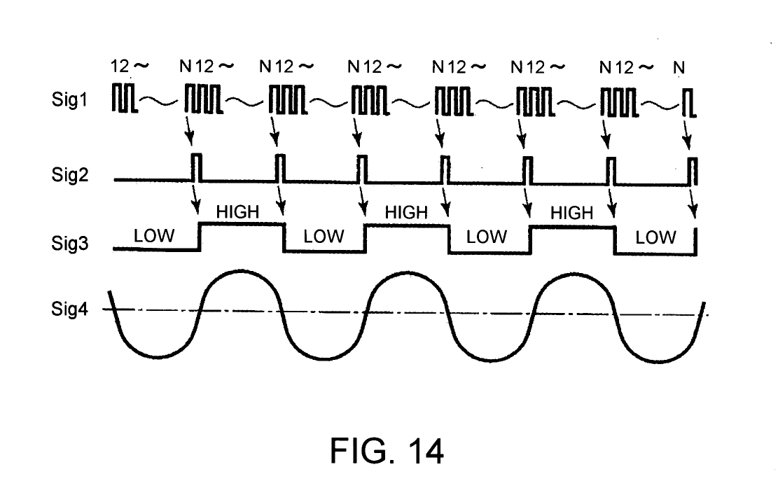

Next, based on a circuit diagram of the dust-proof filter drive circuit 48 shown in FIG. 13 and a timing chart shown in FIG. 14, the driving and operation of the dust-proof filter 21 of the camera with dust-proofing function according to this embodiment will be described. The dust-proof filter drive circuit 48 illustrated here has a circuit structure as shown in FIG. 13, in which signals (Sig1 to Sig4) having waveforms represented in the timing chart of FIG. 14 are generated at respective circuit components to perform control as follows based on these signals.

As illustrated in FIG. 13, the dust-proof filter drive circuit 48 has an N-ary counter 41, a ½ dividing circuit 42, an inverter 43, a plurality of MOS transistors Q00, Q01, and Q02, a transformer T1, and a resistor (R00) 46. A signal (Sig 4) having a predetermined cycle is generated on the secondary side of the transformer T1 in response to turning on/off of the transistor Q01 and the transistor Q02 connected to the primary side of the transformer T1. Based on the signal having the predetermined cycle, the electromechanical conversion element 22a is driven to resonate the vibrating member 22 to which the dust-proof filter 21 is firmly fixed.

The B μcom 50 controls the dust-proof filter drive circuit 48 in a manner to be described below through two IO ports P_PwCont and D_NCnt provided as control ports, and a clock generator 55 existing inside this B μcom 50. The clock generator 55 outputs a pulse signal (basic clock signal) to the N-ary counter 41 at a frequency sufficiently faster than the signal frequency applied to the electromechanical conversion element 22a (piezoelectric substances or the like). This output signal corresponds to a signal Sig1 having a waveform represented in the timing chart of FIG. 14. Then, this basic clock signal is input into the N-ary counter 41.

The N-ary counter 41 counts the pulse signal and outputs a count complete pulse signal each time it reaches a predetermined value “N.” In other words, the basic clock signal is 1/N-divided. This output signal is a signal Sig2 having a waveform represented in the timing chart of FIG. 14. The duty ratio of the divided pulse signal between High and Low is not 1:1. Therefore, the pulse signal is converted through the one-half dividing circuit 42 so that the duty ratio will become 1:1. The converted pulse signal corresponds to a signal Sig3 having a waveform represented in the timing chart of FIG. 14.

When the converted pulse signal is in High state, the MOS transistor Q01 into which this signal has been input is turned on. On the other hand, the pulse signal is applied to the transistor Q02 via the inverter 43. Therefore, when the pulse signal is in Low state, the transistor Q02 into which the signal has been input is turned on. Thus, when the transistor Q01 and the transistor Q02 connected to the primary side of the transformer T1 are turned on alternately, a signal having a cycle like that of the signal Sig 4 as shown in FIG. 14 is generated on the secondary side. The winding ratio of the transformer T1 is determined from the output voltage of the unit of the power source circuit 53 and the voltage necessary to drive the electromechanical conversion element 22a. Note here that the resistor (R00) 46 is provided to prevent excessive current from flowing through the transformer T1.

Upon driving the electromechanical conversion element, it is required that the transistor Q00 be on-state and voltage be applied to the center tap of the transformer T1 from the power source circuit 53. The on/off control of the transistor Q00 shown in FIG. 13 is performed through the IO port P_PwCont. The set value “N” for the N-ary counter 41 can be set from the IO port D_NCnt. Therefore, the B μcom 50 can control the set value “N” to arbitrarily change the driving frequency of the electromechanical conversion element 22a.

The frequency can be determined by the following equation:

fdrv=fpls/2N, where

### N: set value for the counter;

### Fpls: frequency of an output pulse of the clock generator; and

### Fdrv: frequency of a signal applied to the electromechanical conversion element.

The operation based on this equation is performed by a CPU (control part) in the B μcom 50.

Further, this camera 1 has the display part for informing a camera operator of the operation of the dust-proof filter when the dust-proof filter is vibrated at a frequency (frequency of 20 kHz or more) in the ultrasonic region. In other words, when the excitation part (vibrating member) applies vibration to a light-transmissive member to be vibrated (dust-proof filter 21), which is arranged in front of the imaging part and capable of vibrate, the display part (LCD display part 51) of the camera 1 can be operated in conjunction with the operation of the drive circuit of the excitation part to inform the camera operator of the operation of the dust-proof filter (the details will be described later).

The following describes the structure of the ion generation control circuit 401 shown in FIG. 13.

A DAC (digital-to-analog converter) 66 provided inside the B μcom 50 is a circuit for generating an analog voltage according to a digital value inside the B μcom 50. The output of the DAC 66 is output to a DC/DC (direct current/direct current) converter 67 inside the ion generation control circuit 401. The DC/DC converter 67 is supplied with power by the power source circuit 53 and the output thereof is connected to a transistor Q20. This transistor Q20 is connected to a center tap of a transformer T2, and the control terminal thereof is connected to P_PWCont2 of the B μcom 50. Transistors Q21 and Q22 are connected to both sides of the primary center tap of the transformer T2, while diodes D20 and D21, capacitors C20 and C21, and resistors R20 and R21 are arranged as shown in FIG. 13 on the secondary side of the transformer T2 and connected to an output OUT 2 through a polarity switching SW 70. Further, the secondary center tap of the transformer T2 is connected to an ADC (analog-to-digital converter) 68 of the B μcom 50 through the diode D22, the capacitor C22, and the resistors R22 and R23.

The transformer T2 is a DC power source for applying voltage to the ion generator 403. The transformer T2 can output a positive voltage and a negative voltage from the output terminal OUT2 to a grounded terminal OUT1 and a voltage having a reversed polarity to OUT 2 from an output terminal OUT3. Thus, the transformer T2 generates a high voltage necessary for corona discharge. Then, an AC signal input into the primary side of the transformer T2 is generated by the transistors Q21 and Q22. As a signal for driving Q21 and Q22, the same driving signal as that for Q01 and Q02 in the dust-proof filter drive circuit 48 is used. The driving frequency needs to be set according to the characteristics of the circuit. Therefore, if a high voltage is applied to the electrodes 403a1 of the ion generator 403, the value for the N-ary counter has to be set according to the characteristics of the circuit.

The transistor Q 20 turns on or off power supplied from the DC/DC converter 67 to the primary side of the transformer T2. When the voltage is applied to the ion generator 403, the transistor Q20 has to be on-state. The transistor Q20 is controlled by a port P_PWCont2 of the B μcom 50. The DC/DC converter 67 converts the output voltage of the power source circuit 53 to a predetermined voltage. The output voltage of the DC/DC converter varies with Vref supplied from the B μcom 50. A voltage K times of Vref is output from a regulator into the transformer T2. The transformer T2 increases the primary side voltage by a factor of M and outputs the increased voltage. Thus, a voltage of Vref·K·M is generated on the secondary side of the transformer T2. This voltage is rectified and output to the terminal OUT2. The Vref is generated by the DAC (digital-to-analog converter) 66 arranged inside the B μcom 50. Therefore, the B μcom 50 can set the output voltage of the output terminals OUT 2 and OUT3 to a desired value by controlling the DAC 66.

The diode D20 and the capacitor C20 connected to the secondary side of the transformer T2 rectify the positive half cycle of the AC voltage output from the transformer T2 to generate a positive voltage of Vref-K-M. The resistor R20 discharges electric charges accumulated in C20 when a voltage is not applied to the dust collecting box 404. On the other hand, the diode D21 and the capacitor C21 connected to the secondary side of the transformer T2 rectify the negative half cycle of the AC voltage output from the transformer T2 to generate a negative voltage of Vref-K-M. The resistor R21 works the same way as the resistor R20. The positive voltage is input to a terminal 1 of the polarity switching SW 70 and a terminal 4 of a polarity switching SW 71, and the negative voltage is input to a terminal 2 and a terminal 5. The polarity switching SW 70 connects either the terminal 1 or the terminal 2 to a terminal 3. The connection switching is controlled by a terminal P_PwChg1 of the B μcom. When the terminals 1 and 3 are connected, the positive voltage is applied to the electrodes 403a1 of the ion generator 403, while when the terminals 2 and 3 are connected, the negative voltage is applied to the electrodes 403a1. Similarly, the polarity switching SW 71 connects either the terminal 4 or the terminal 5 to a terminal 6. The connection switching is controlled by a terminal P_PwChg2 of the B μcom. When the terminals 4 and 6 are connected, the positive voltage is applied to the electrodes 403a1 of the ion generator 403, while when the terminals 5 and 6 are connected, the negative voltage is applied to the electrodes 403a1. The polarity switching SWs 70 and 71 are made up of high-voltage relays or semiconductor elements.

The center tap provided on the secondary side of the transformer T2 is to monitor the voltage. The AC voltage appearing at the center tap is converted to a DC voltage through a voltage monitor circuit consisting of the diode D22, the capacitor C22, and the resistors R22 and R23. This voltage is measured by the ADC (analog-to-digital converter) 68 arranged inside the B μcom 50. A high voltage generated by the transformer T2 is detected from the center tap, and the detected voltage is divided. Then, the divided voltage is further divided by the resistors R22 and R23, and input into the ADC 68.

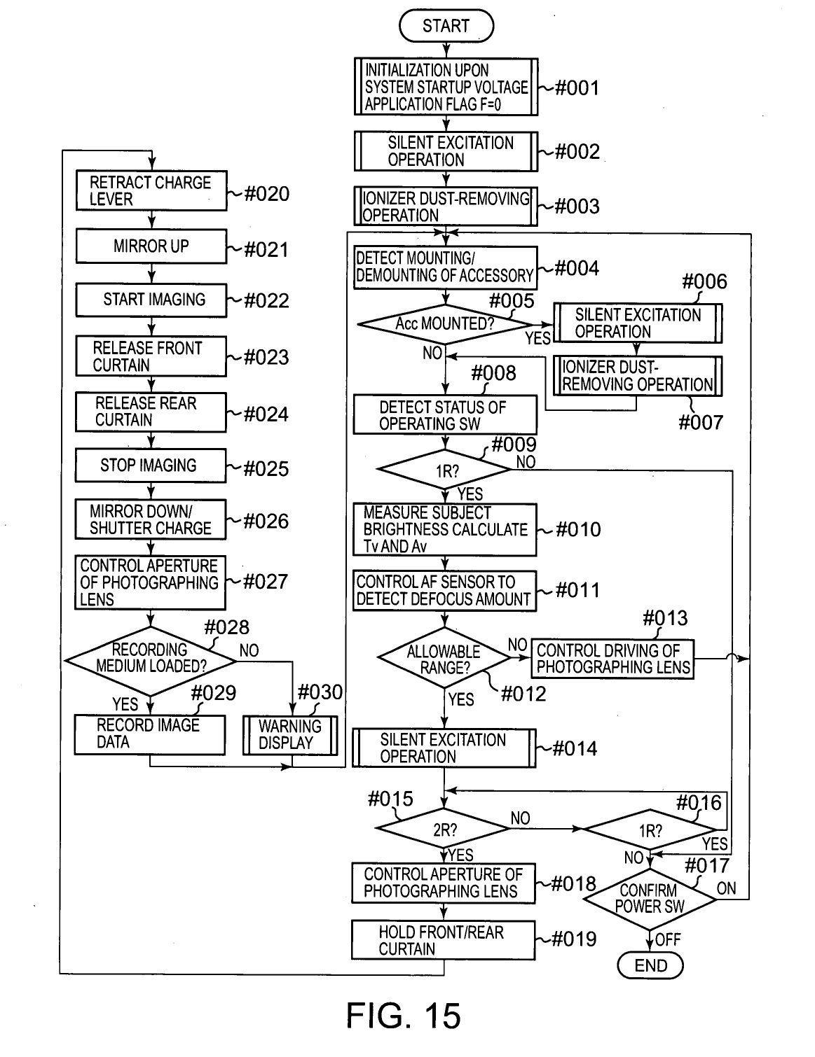

The following describes a specific control operation performed by the camera body control microcomputer (B μcom) 50 with reference to FIGS. 15 to 19.

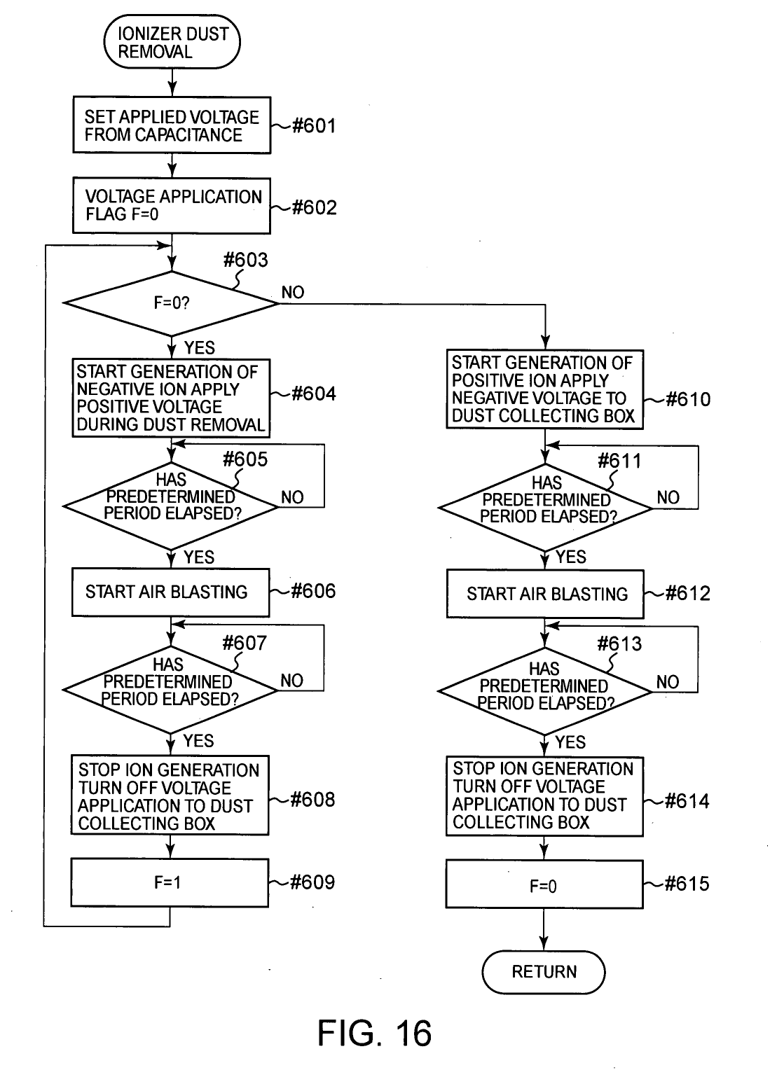

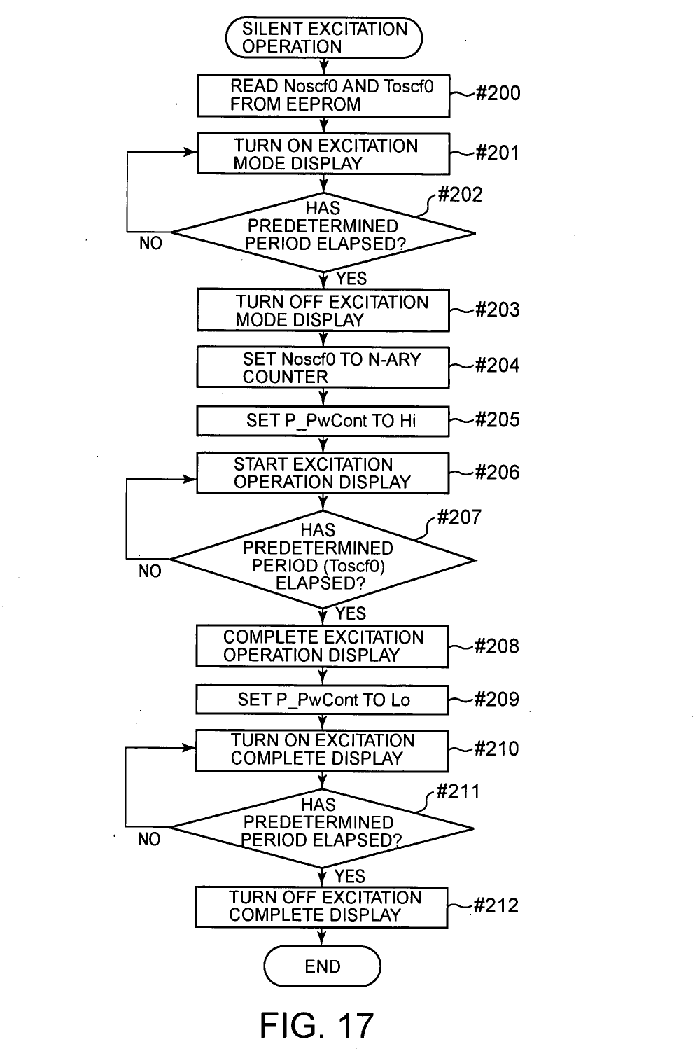

FIG. 15 is a flowchart of camera operation control of the embodiment, illustrating a procedure for a camera sequence (main routine) executed by this B μcom 50. FIG. 16 is a flowchart showing an ionizer dust-removing operation called from the main routine. FIG. 17 is a flowchart illustrating a procedure for a subroutine “silent excitation operation” (including the display operation).

A control program related to the flowchart shown in FIG. 15 starts the operation when a power source SW (not shown) of the camera 1 is turned on. First, in step #001, processing for booting the camera system is performed. In other words, the power source circuit 53 is controlled to supply power to each of the circuit units constituting the camera system. Further, each circuit is initialized and a voltage application flag F to the ion generator 403 is set to “0.” Then, the subroutine “silent excitation operation” (see FIG. 17) to be described later is called to vibrate the dust-proof filter 21 silently (i.e., at a frequency beyond an audible range) (#002). Here, the audible range is set to fall within a range from 20 Hz to 20000 Hz based on the hearing abilities of ordinary people. After that, a subroutine “ionizer dust-removing operation” to be described later is called to perform the dust removal operation using the ion generator 403 (#003).

Subsequent steps #004 to #029 are a step group executed on a periodic basis. First, in step #004, the mounting or demounting of an accessory on or from the camera is detected. For example, the mounting of the lens barrel 12 as one of accessories on the camera body section 11 is detected. This mounting/demounting detection operation is performed by the B μcom 50 communicating with the L μcom 5 to check the mounting/demounting state of the lens barrel 12. The accessory to be detected is not limited to the lens barrel, and other accessories can be detected, such as a bellows, an extension tube, etc., as long as they are to be connected to the camera body through the lens opening part. When the mounting of a predetermined accessory on the camera body is detected, the subroutine “silent excitation operation” is called at step #006 to vibrate the dust-proof filter 21 for dust removal. After completion of this subroutine “silent excitation operation,” the subroutine “ionizer dust-removing operation” is called next (#007). Then, after completion of the dust removal operation using ions generated by the ion generator 403, the procedure proceeds to step #008.

During a period over which an accessory, especially the lens barrel 12, has not been mounted on the camera body section, since dust is likely to stick to each lens, the dust-proof filter 21, etc., it is effective to perform the dust removal operation when the mounting of the lens barrel 12 is detected in the manner as mentioned above. Further, upon changing the lens, since outside air is circulated inside the camera and dust is likely to enter and stick to the inside of the camera body, it is useful to remove dust upon changing the lens. On the other hand, when demounting of the lens barrel 12 from the camera body section 11 is detected in step #005, or when the lens barrel 12 remains mounted, the procedure goes to the next step #008. In step #008, the status of the predetermined camera operating switch part 52 arranged on the camera is detected.

Next, it is determined whether a first release SW (not shown) to be turned on with a half press of the release button 17 is operated based on the output of the camera operating SW 52 and the on/off state of the SW (#009). The state is read out, and if it is determined that the first release SW has not been operated for a predetermined period of time based on the output of a timer function (not shown), the procedure shifts to step #017 to be described later to perform end processing (sleep mode processing, etc.). On the other hand, if the release SW is turned on, the procedure goes to step #010 to acquire subject brightness information from the photometric circuit 32. Then, from this information, the exposure time (Tv value) of the CCD 27 and the aperture set value (Av value) of the lens barrel 12 are calculated.

After that, in step #011, detected data of the AF sensor unit 30a is acquired via the AF sensor drive circuit 30b. Based on this data, the defocus amount is calculated. Then, in step #012, it is determined whether the calculated defocus amount falls within an allowable range. If No in step #012, the driving of the photographing optical system 12a is controlled in step #013 through the L μcom 5 and the lens drive mechanism 2, and the procedure returns to step #004. On the other hand, if the defocus amount falls within the allowable range, the subroutine “silent excitation operation” is called to start silent vibration of the dust-proof filter 21 in order to perform the dust removal operation (#014).

Next, it is determined whether a second release SW (not shown) to be turned on with a full press of the release button 17 is operated (#015). When the second release SW is on-state, the procedure goes to step #018 to start a predetermined shooting operation (the details will be described later), while when it is off-state, the procedure goes to step #016. In step #016, it is checked whether the first release SW remains on. If the first release SW remains on, the procedure returns to step #015, while if it is off-state, the procedure goes to step #017. While the camera operator is keeping on pressing the release button 17 halfway, the camera enters a waiting state in which steps #015 and #016 are repeated. Under this condition, if the camera operator removes his or her finger from the release button 17, the state of the power source SW is detected (#017). Then, if the power source SW is off-state, the end processing is performed, while if it is on-state, the procedure returns to step #004.

Returning to step #015, if the second release SW is turned on, an imaging operation is started. The imaging operation is to control an electronic imaging operation for a time period corresponding to a preset time period (exposure time) for exposure. Steps #018 to #025 as the shooting operation are executed to perform image capturing of a subject in a predetermined order. First, the Av value is sent to the L μcom 5 to instruct the driving of the aperture 3 (#018). Then, a front curtain and a rear curtain of the focal-plane shutter 14 are held by electromagnetic actuators (hereinafter abbreviated as “Act”) (#019) to retract a charge lever of the focal-plane shutter 14 (#020). After that, the reflecting mirror 13b is moved to UP position (#021), and the image processing controller 40 is instructed to execute the “imaging operation” (#022). Then, the electromagnetic Act holding the front curtain of the shutter part 14 is turned off to start the traveling of the front curtain (#023). Then, according to the time period indicated by the Tv value, the electromagnetic Act holding the rear curtain of the shutter part 14 is turned off to start the traveling of the rear curtain (#024). Thus, the shutter opening/closing operation is performed to complete the exposure (imaging) to the CCD 27 (#025). Then, the reflecting mirror 13b is moved to DOWN position and the shutter part 14 is charged (#026). Then, the L μcom 5 is instructed to return the aperture 3 to the maximum aperture position (#027), and the sequence of imaging operation steps is completed.

Then, in step #028, it is determined whether the recording medium 39 is loaded in the camera body section 11. If No in step #028, a warning is displayed in step #030. After that, the procedure returns to step #004 again to repeat the above-mentioned steps. On the other hand, if the recording medium 39 is loaded, the image processing controller 40 is instructed in step #029 to record shot image data on the recording medium 39. After completion of recording the image data, the procedure returns to step #004.

The above description is about the main routine, and the following describes the aforementioned subroutines with reference to FIGS. 16 and 17. First, the subroutine “ionizer dust-removing operation” will be described using FIG. 16. When the procedure shifts from the main routine shown in FIG. 15 to the subroutine “ionizer dust-removing operation,” the capacitance detector 402 detects capacitance to set the applied voltage based on the detection result (#601). After that, the voltage application flag F is set to “0” (#602). This flag is to decide whether the applied voltage to the ion generator 403 should be positive or negative. If F=0, negative voltage is applied, while if F=1, positive voltage is applied.

In step #603, it is detected whether the voltage application flag F is “0.” As a result of detection, if F=0, the procedure goes to step #604. In step #604, based on the applied voltage set in step #601, a potential, which is negative with respect to the ground voltage of the dust-proof filter 21, is applied to the electrodes 403a1 of the ion generator 403, while a positive potential is applied to the dust collecting box 404. This voltage application control is performed by switching the polarity switching SWs 70 and 71 of the ion generation control circuit 401. Under this condition, the voltages continue to be applied to the ion generator 403 and the dust collecting box 404 for a predetermined period of time (#605). After that, a flow of air is blown off by the air blower 410 (#606). This airflow and the dust collecting box 404 allow negative ions to move downward along the dust-proof filter 21 in the space between the shutter curtain 14a and the dust-proof filter 21. The negative ions electrically neutralize dust having positive surface charges to cancel the electric attractive force in order to remove the dust from the surface of the dust-proof filter 21. The removed dust moves through the airflow and is collected into the dust collecting box 404 provided at the bottom. This air blasting operation is continued for a predetermined period of time, and after the predetermined period of time has elapsed (#607), the voltage application to the ion generator 403 and the dust collecting box 404 is stopped (#608). After that, the voltage application flag is set to F=1 (#609), and the procedure returns to step #603.

Returning to step #603, the voltage application flag F is determined. In this case, since F=1 is set in step #609, the procedure follows the No branch to go to step #610. In step #610, a positive voltage is applied to the ion generator 403, though the negative voltage is applied in the aforementioned steps #603 to #608, while a negative voltage is applied to the dust collecting box 404. This condition is continued for a predetermined period of time (#611). This applied voltage switching is performed by controlling the polarity switching SWs 70 and 71. After that, air blasting is started by the air blower 410 (#612). This airflow allows positive ions to move downward along the dust-proof filter 21 in the space between the shutter curtain 14a and the dust-proof filter 21. The positive ions electrically neutralize dust having negative surface charges to cancel the electric attractive force in order to remove the dust from the surface of the dust-proof filter 21. The removed dust moves through the airflow and is collected into the dust collecting box 404 provided at the bottom. This air blasting operation is continued for a predetermined period of time, and after the predetermined period of time has elapsed (#613), the voltage application to the ion generator 403 and the dust collecting box 404 is stopped (#614). After that, the voltage application flag F is set to “0” (#615), and the procedure returns to the main routine after completing the subroutine.

Thus, the “ionizer dust-removing operation” performed after system startup (#003) and after mounting of an accessory (#007), during which dust is likely to stick to the dust-proof filter 21, is performed using negative ions and positive ions generated by the ion generator 403. This can ensure that dust adhering on the surface of the dust-proof filter 21 is removed. In the embodiment, the “ionizer dust-removing operation” is performed as mentioned above after system startup and after mounting of the accessory, but the present invention is not limited to these timings. For example, the timing of performing this operation can change arbitrarily, such as during the imaging operation or at all times when the power source is on-state. Further, upon performing the “ionizer dust-removing operation,” the ion generator 403 generates a set of negative and positive ions, but only either of them may be generated if a simple dust removal operation is enough.

Next, FIG. 17 is the flowchart illustrating a procedure for the subroutine “silent excitation operation.” FIG. 18 shows a graph representing the waveform of a resonance frequency repeatedly supplied to the excitation part in this silent vibration-exciting operation.

Since the subroutine “silent excitation operation” in FIG. 17 is a routine aiming to perform the excitation operation to remove dust from the dust-proof filter 21, the vibration frequency f0 is set to a resonance frequency of the dust-proof filter 21. For example, in this case, since it is set to 40 kHz, or at least 20 kHz or more, the operation is silent to the user. First, in step #200, data related to the driving time (Toscf0) to vibrate the dust-proof filter 21 and the driving frequency (resonance frequency) Noscf0 are read out from a predetermined area in the EEPROM 29. Then, an excitation mode is displayed (#201), and it is determined whether a predetermined period of time has elapsed since the start of the display (#202). If the predetermined period of time has not elapsed, the excitation mode display is continued, while after the predetermined period of time has elapsed, the excitation mode display is stopped (#203). After that, the driving frequency NoscfO is output to the N-ary counter 41 of the dust-proof filter drive circuit 48 from the output port D_NCnt of the B μcom 50 (#204).

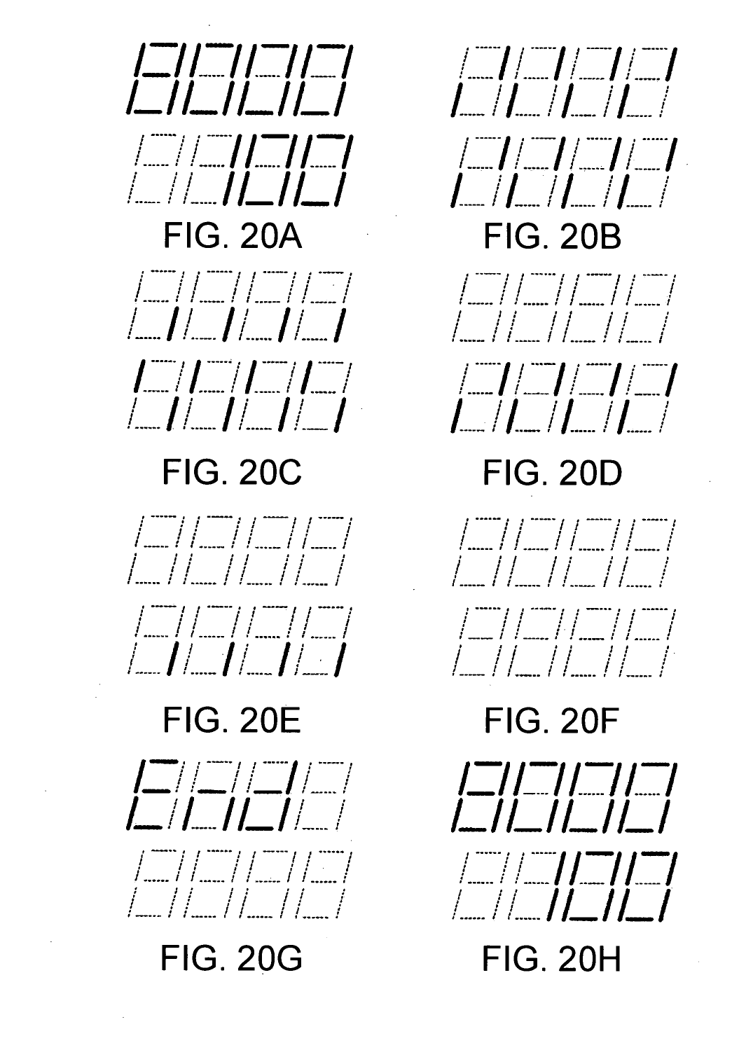

Then, in subsequent steps #205 to #209, the dust removal operation is performed. First, the control flag P_pwCont of the B μcom 50 is set to Hi (High value) to turn on the transistor Q00 of the dust-proof filter drive circuit 48 in order to make this circuit 48 active. Further, a display is provided at the timing of setting the control flag P_pwCont to Hi to indicate that the excitation operation is started (#206). Next, in step #207, it is determined whether a predetermined period of time has elapsed since the start of the display (and the start of the excitation operation). If the predetermined period of time has not elapsed, the excitation operation display is continued, while after the predetermined period of time has elapsed, the excitation operation display is completed (#208). This excitation operation display is configured to vary its content over time or over the course of dust removal (see FIG. 20). In this case, the predetermined time is the duration of the excitation operation to be described later, and is substantially equal to Toscf0. Further, when the control flag P_pwCont is set to Hi to perform dust removal (#205), the vibrating member 22 vibrates the dust-proof filter 21 at a predetermined driving frequency (NoscfO) to shake off dust adhering to the filter surface. At the instant when the dust adhering to the dust-proof filter surface is shaken off in this dust removal operation, vibration of air occurs to generate ultrasonic waves. Note that if the excitation part is driven at the driving frequency NoscfO, since it does not produce a sound in the audible range so that ordinary people cannot hear the sound, it is no special problem from a practical standpoint.

The procedure waits for the predetermined driving time period (Toscf0) while vibrating the dust-proof filter 21 (#207), and after the predetermined driving time period (Toscf0) has elapsed, the control flag P_pwCont is set to Lo (Low value) (#209) to turn on an excitation complete display (#210) and stop the dust removal operation. Then, after a predetermined period of time has elapsed (#211), the excitation complete display is turned off (#212) to complete the display. Then, the procedure returns to the step immediately following the step from which this subroutine was called.

The vibration frequency f0 (resonance frequency (Noscf0)) and the driving time (Toscf0) applied to this subroutine indicate a waveform shown in the graph of FIG. 18. In other words, it becomes a continuous waveform with a certain vibration (f0=40 kHz) repeated for the time period (Toscf0) enough for dust removal. This vibration mode adjusts and controls the resonance frequency supplied to the excitation part.

Note that if this subroutine is executed during the exposure operation, the above-mentioned alternative example can be realized. In other words, when the dust-proof filter 21 is operated during exposure to the image pickup device, the shadows of dust sticking to the dust-proof filter 21 are prevented from being cast on an image during shooting, and even if dust clings to the dust-proof filter 21 and hence is incapable of being removed by vibration, the density of shadows of dust can be reduced. Therefore, there can be provided an electronic camera having an effect of reducing the chances of casting the shadows of dust on an image more effectively than the conventional dust-proof mechanism for removing dust by vibration alone. Further, since the excitation operation status is displayed, the electronic camera is also capable of informing the camera operator of the operation of the dust-proof mechanism.

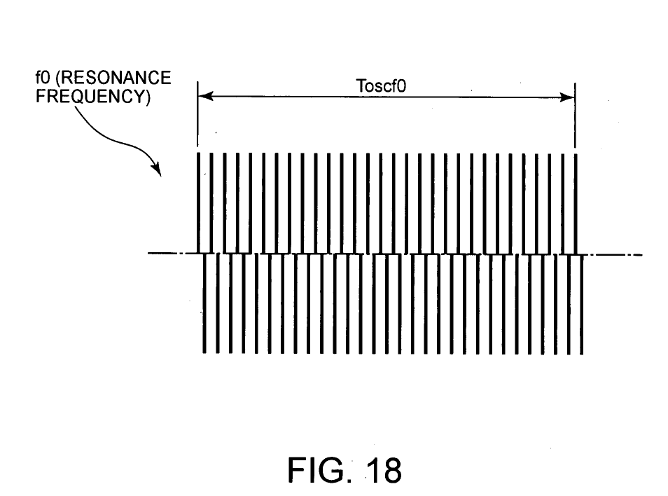

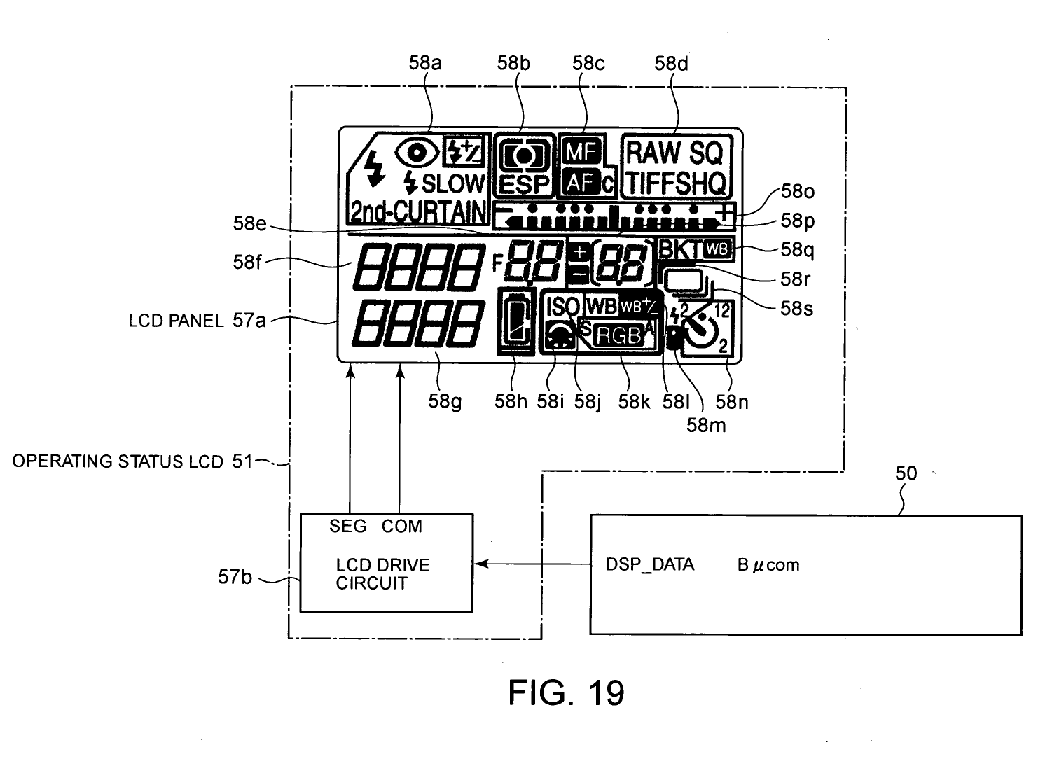

FIG. 19 shows the details of the display part of the present invention. The operating status LCD 51 is comprised of an LCD panel 57a and a LCD drive circuit 57b. In FIG. 19, the LCD panel 57a is shown in such a condition that all segments light up. Each of segment groups denoted with reference numerals 58a to 58s in the LCD panel 57a shows a pattern of camera status to be described below.

That is, reference numeral 58a denotes a pattern indicating a state of flash mode, 58b denotes a pattern indicating a state of light metering mode, 58c denotes a pattern indicating a state of focus mode, 58d denotes a pattern indicating a state of image quality mode, 58e denotes a pattern indicating a state of aperture value, 58f denotes a pattern indicating a state of shutter speed, and 58g denotes a pattern indicating the number of pictures that can be taken. Reference numeral 58h denotes a pattern indicating the amount of remaining battery power, 58i denotes a pattern indicating a state of image adjustment, 58j denotes a pattern indicating a state of ISO sensitivity, 58k denotes a pattern indicating a state of color space, 581 denotes a pattern indicating a state of white balance, 58m denotes a pattern indicating a state of remote control, and 58n denotes a pattern indicating a state of self-timer. Further, reference numeral 58o denotes a pattern indicating states of exposure level indicator, exposure compensation indicator, and AF frame, 58p denotes a pattern indicating the number of pictures that can be continuously taken and a state of exposure compensation value display, 58q denotes a pattern indicating a state of auto bracketing, 58r denotes a pattern indicating a state of noise reduction, and 58s denotes a pattern indicating a state of sequential shooting.

Now, data on a display content are output to the LCD drive circuit 57b from IO port DSP_DATA of the B μcom 50. Then, in response to the display content data, the LCD drive circuit 57b outputs an SEG signal to select a specific pattern (e.g., specific character, number, icon) formed in each segment group of the LCD panel 57a and a COM signal to select a specific segment group used for forming a specific pattern. Thus, the pattern corresponding to the display content data is displayed on the LCD panel 57a.

FIGS. 20A to 20H show a more specific display content of the present invention, illustrating an example of displaying the state of the dust removal operation. Here, in FIG. 19, only two patterns, namely the pattern 58f indicating the shutter speed and the pattern 58g indicating the number of pictures that can be taken are shown. The upper part consists of four segment groups indicating the shutter speed, each character consisting of seven segments, and the lower part consists of four segment groups indicating the number of pictures that can be taken, each character consisting of seven segments. These segments usually indicate the shutter speed and the number of pictures that can be taken. For example, as shown in FIG. 20A, 8000 and 100 are displayed indicating a shutter speed of 1/8000 second and 100 pictures as the number of pictures that can be taken, respectively. Here, when the silent excitation operation is started, the display turns to a state as shown in FIG. 20B, and the display of FIG. 20B is continued until the start of the excitation operation. Next, when the excitation operation is started, the display turns to states in FIGS. 20C, 20D, 20E, and 20F sequentially in this order. Then, when the excitation operation is stopped, the display of FIG. 20G is continued for a predetermined period of time, and the sequence of operations is completed. After the display is completed, the display returns to the state in FIG. 20H, which is the same state as the first display.

Note that although the above description has been made by taking, as an example, the display during the dust removal operation by performing the excitation operation, a similar display to inform the camera operator can also be provided during the dust removal operation using ions generated by the ion generator 403.

As described above, according to the embodiment of the present invention, the ion generator 403 is arranged in the space between the dust-proof filter 21 and the shutter curtain 14a to perform dust removal using ions upon power-on and upon mounting the lens barrel 12a. Therefore, the optical member (dust-proof filter 21) for image formation is not left with dust sticking thereto, thereby making it possible to reduce the chances of casting the shadows of dust and the like on an image.

As described above, although the preferred embodiment of the present invention has been described, the aforementioned embodiment can be changed or modified as follow.

For example, in the embodiment, the element from which dust is to be removed is the dust-proof filter 21, but the present invention is not limited thereto. For example, any other optical element, such as the optical low-pass filter, the cover glass, etc., can be a target for dust removal as long as the optical element has a surface through which a light flux passes upon optical image formation and from which dust is to be removed. Further, the space in which ions flow is the space closed by the dust-proof filter 21 and the shutter curtain 14a, but a partially open shield plate can be provided instead. Further, the ion generator 403 is arranged in the upper portion of the dust-proof filter 21, but the arrangement is not limited thereto, and it can be arranged at the bottom or either to the right or left.

Further, in the embodiment, air blasting is conducted by providing only the air blower 410, but a suction device for sucking air can also be provided in the vicinity of the dust collecting box 403 to suck in dust electrically neutralized by ions. If the suction device is provided, the dust collecting effect can be more improved. In particular, if a hole is provided in the dust collecting box 403 and the suction device is arranged to communicate with the hole, the dust collecting effect is much more improved. Further, upon dust removal using ions, dust is first removed using negative ions and then using positive ions, but this procedure can, of course, be performed in reverse order. Further, any other dust removal method, such as a method of removing dust with electrostatic action by moving a positively or negatively charged dust removing plate over the dust-proof filter surface, or a mechanism for removing dust from the dust-proof filter using a wiper, can, of course, be used in combination with the dust removal method using the excitation part.

Further, in the aforementioned embodiment, the electromechanical conversion element is comprised of piezoelectric substances, but any other material such as an electrostrictive material or ultra-magnetostrictive material can, of course, be used. Further, the vibration target is not limited to the dust-proof filter 21 exemplified above, and it can be any other light-transmissive member or the like (e.g., the cover glass, a half mirror, etc.) arranged on the optical path. In this case, it is assumed that the member is to shake off dust sticking to its surface by vibration and resonate with the vibration to generate a sonic wave in the audible range. Further, the frequency and the driving time associated with the vibration are set to values depending on the member.

The electronic imaging apparatus to which the present invention is applied is not limited to the electronic camera (digital camera) exemplified above, and it can be modified as necessary for practical use as long as the dust removal function is necessary for the apparatus. As a specific example, the dust-proof mechanism of the present invention can be provided between a liquid crystal panel and a light source in a liquid crystal projector. Various other modifications can be possible without departing from the scope of the present invention.

According to the embodiment of the present invention, there can be realized an image apparatus, such as an electronic camera, a liquid crystal projector, etc., capable of preventing dust from sticking to an image pickup device or a liquid crystal panel using electrostatic dust-removing effects of the dust-proof filter, and capable of reducing the chances of casting dust on the image pickup device or the screen when the dust is too tiny to be shaken off even by ultrasonic vibration.

While there has been shown and described what is considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image apparatus comprising:
an image surface on which an optical image is formed;
a dust-proof member having a transparent portion in a region corresponding to the image surface, the transparent portion arranged to face the image surface with a predetermined space therebetween;
an ion generator provided near the dust-proof member to generate negative or positive ions; and
a transport part for moving ions generated by the ion generator along the surface of the dust-proof member.

2. The image apparatus according to claim 1 wherein the transport part has a guide member spaced a predetermined distance from the dust-proof member to regulate a flow of ions.

3. The image apparatus according to claim 1 wherein the transport part has a dust collecting part arranged on the opposite side of the ion generator across the transparent portion so that a voltage having a reverse polarity to the polarity of ions generated by the ion generator is applied to the dust collecting part.

4. The image apparatus according to claim 1 wherein the transport part has an air blower.

5. The image apparatus according to claim 1 wherein the ion generator has a first operating mode for generating negative ions and a second operating mode for generating positive ions.

6. The image apparatus according to claim 1 wherein the ion generator has a protruding-shape electrode to which a negative or positive voltage is applied and a grounded electrode spaced a predetermined distance from the protruding-shape electrode, and
a capacitance between the protruding-shape electrode and the grounded electrode is detected prior to ion generation by the ion generator.

7. The image apparatus according to claim 6 wherein the capacitance is detected from a current flowing when a frequency voltage lower than the voltage for ion generation by the ion, generator is applied to the electrode.

8. An imaging apparatus comprising:
an image pickup device for acquiring an image signal corresponding to light, irradiated on a photoelectric conversion surface thereof;
a dust-proof member having a transparent portion in a region corresponding to the photoelectric conversion surface, the transparent portion arranged to face the image pickup device with a predetermined space therebetween;
an ion generator provided near the dust-proof member to generate negative or positive ions; and
a transport part for moving ions generated by the ion generator along the surface of the dust-proof member.

9. The imaging apparatus according to claim 8 wherein the transport part has a guide member spaced a predetermined distance from the dust-proof member to regulate a flow of ions.

10. The imaging apparatus according to claim 9 wherein the guide member is a focal-plane shutter.

11. The imaging apparatus according to claim 8 wherein the transport part has a dust collecting part arranged on the opposite side of the ion generator across the transparent portion so that a voltage having a reverse polarity to the polarity of ions generated by the ion generator is applied to the dust collecting part.

12. The imaging apparatus according to claim 8 wherein the transport part has an air blower.

13. The imaging apparatus according to claim 8 wherein the ion generator has a first operating mode for generating negative ions and a second operating mode for generating positive ions.

14. A device for reducing dust-effects on an image used in an image apparatus having an image surface on which an optical image being formed, the device comprising:
a dust-proof member having a transparent portion in a region corresponding to the image surface, the transparent portion arranged to face the image surface with a predetermined space therebetween;
an ion generator provided near the dust-proof member to generate negative or positive ions; and
a transport part for moving ions generated by the ion generator along the surface of the dust-proof member.

15. The device according to claim 14 wherein the transport part has a guide member spaced a predetermined distance from the dust-proof member to regulate a flow of ions.

16. The device according to claim 14 wherein the transport part has a dust collecting part arranged on the opposite side of the ion generator across the transparent portion so that a voltage having a reverse polarity to the polarity of ions generated by the ion generator is applied to the dust collecting part.

17. The device according to claim 14 wherein the transport part has an air blower.

18. A method of removing dust adhering to a surface of an optical member inside a single-lens reflex digital camera, the method comprising:
generating ions by means of an ion generator;
driving air containing the generated ions to flow over the surface of the optical member; and
separating, from air, dust which had been on the optical member but was captured by the air flowing over the optical member, and anchoring the separated dust.
